(19) United States
(12) Patent Application Publication
(10) Pub. No.: US 2007/0288415 A1
(43) Pub. Date: Dec. 13, 2007

(54) Decision construct for configuring a networked computing environment

(76) Inventors: J. Robert Sapp, Pasadena, MD (US); Michael Brown, Beltsville, MD (US); L. Wayne Precht, Laurel, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/725,639

(22) Filed: Mar. 20, 2007

Related U.S. Application Data
(60) Provisional application No. 60/784,045, filed on Mar. 20, 2006.

(51) Int. Cl. G06F 17/00

(52) U.S. Cl. 706/47

(57) ABSTRACT

A decision construct provides a system and method of configuring/managing/controlling a networked computing environment, such as a learning technology/platform. The construct provides one or more permission levels associated with one or more users of the system, such as independent permission levels for a provost, a dean, a department chair, a course director, and a faculty member, wherein the permission levels allow differentiation amongst the users of the system as to various decisions that are made to configure the networked computing environment. The decisions are made by the user through interaction with decision cells that the user(s) is allowed access to based on their associated permission level. The access and decisions that the user is allowed to make affect various component features, such as the display and functional capabilities, of the networked computing environment. The number and types of permission levels and decision cells made available to the different permission levels is a feature determined through the construct and allows for the customization of permission levels and thereby the customization of the configuration of the networked computing environment.

### CROSS REFERENCE TO RELATED APPLICATION

The present application claims priority under 35 U.S.C. §119 to the U.S. Provisional Application Ser. No. 60/784,045, filed on Mar. 20, 2006, which is herein incorporated by reference in its entirety.

### FIELD OF THE INVENTION

The present invention generally relates to the field of networked computing environments, such as learning platforms, and particularly to a configuration construct for the environment that provides a management system and method for such environments.

### BACKGROUND OF THE INVENTION

The use of networked computing environments, such as net or web based learning platforms and systems, exemplified by internal networks within businesses of various sizes, on-line Universities/schools and on-line classrooms, and the like, are well known. These various networked environments may be made available to users over the Internet, Intranets, and the like, which are also well known. Various entities, such as businesses and institutions, including large and small companies, universities, colleges, and others are utilizing networked computing environments, such as online, net/web-based, or net/web-enhanced learning technologies and capabilities to provide not only places for the exchange of information, such as work groups and classrooms, but entity wide services and options to reach a broader range of people or students and provide more effective and efficient service locally and around the world. Taking for example, the university setting, as more institutions and classrooms migrate from physical to virtual, greater attention is needed in providing an interface and control mechanism over the online environment, more particularly between the various policies (i.e., academic policies) of these institutions and the learning technologies they are deploying. In a business setting similar needs for a coherent and adaptable policy distribution capability may be experienced for the management of their networked environment.

Typically in the University setting, the interface for these virtual institutions and/or classrooms may be controlled through the use of learning management systems (LMS) and course management systems (CMS). Unfortunately, many currently available and utilized LMS and CMS that support the growing number of networked environments, including online, net/web-based, and net/web-enhanced learning platforms and systems that may offer various capabilities, such as one or more on-line courses, provide inadequate capabilities and facilities for reflecting the policies, such as academic policy, of these institutions. As a result, the LMS and CMS currently available may not effectively implement policy within the networked computing environment/platform(s) due to their inability to conform to the needs of the institution(s) they support. All the decisions that are required to create such an online networked computing environment, such as access to resources, the look and feel of user interfaces, read/write privileges, and course elements such as syllabi, conferences, gradebooks, etc., are often determined not by the requirements of the institution but instead by the limitations of the software.

The ability to create networked computing environments, such as the online or net/web based learning platforms (i.e., classrooms) that are consistent with academic policy or net/web based business platforms (i.e., corporate Intranet) that are consistent with company policies, may be mitigated to a large degree by a single interface within the learning technology where the requirements of the institution can be addressed. Typically, policy(s) within any setting is not determined or deployed in a single process or at a single point. These decisions may occur at many levels within an entity's governance structure, such as those governance structures that may be found within Universities or corporations. Further, decisions made for one school or department within the institution or one work group or division within the corporation may not be true for the entire entity. For these reasons, businesses, colleges, and universities may be better served by having a multi-level interface their networked computing environments, such as the LMS and CMS described above, that is capable of reflecting the organizational structure of the business and/or institution.

For example, in higher education, decisions about classroom policy may be made and molded through a series of descending levels, such as through provosts, deans, department chairs, program directors, course leaders and faculty. Some decisions may be university-wide, such as codes of academic integrity, honor codes or term schedules. These are often made by the provost. A dean may make a determination about admissions or grading policy for a specific school within the university. Department chairs may make decisions about writing or citation standards and cross-curricular prerequisites. Program directors may establish course requirements. Course leaders may select texts, determine common assessments, and write learning objectives and other course standards. Faculty may typically make decisions about learning strategies and methods and provide instruction.

Therefore, it would be desirable to provide a management tool, system and method for a networked computing environment/platform that allows for multi-level interfacing to more accurately reflect the hierarchical/multi-level decision making structure and/or configuration of the entity.

### SUMMARY OF THE INVENTION

Accordingly, the present invention provides a decision construct, which may be referred to as a decision policy console (DPC) and/or academic decision policy console (APDC), that is executable upon a computing system and capable of implementing and integrating the input from a multi-level user interface for configuring/controlling an entity's networked computing environment. The decision construct may implement a similar decision structure/configuration as that of the entity or may implement a decision structure/configuration for the networked computing environment that is different from that of the entity. The decision construct of the current invention may assist University employees, such as faculty and administrators, in customizing learning management technologies to create, configure, and control online learning environments/learning platforms that reflect the policies of the institution. Alternatively the decision construct may assist any networked computing environment, such as those created by businesses and other institutions, in customizing their technologies to create, configure, and control online environments/platforms that reflect their policies.

The decision construct provides a configuration tool (control mechanism) for the networked computing environment. For example, a University may utilize a learning platform over a networked computing environment which provides a virtual university setting for students and through which students may take University course work and access the resources of the University. The decision structure of the University, which is to be reflected in the learning platform, may require 4 permission levels through which decisions regarding all components (i.e., aspects/features, displays, functional capabilities, and the like) of the virtual University must be vetted. The decision construct of the current invention allows for the integration of the 4 permission levels to provide the users with those permissions the ability to control the implementation over the networked computing environment of the learning platform of all the various components.

The decision construct of the current invention is capable of implementing the hierarchical/multi-level decision configuration of the entity to be accurately reflected in and throughout the networked computing environment/platform. The decision construct provides a user control over the networked computing environment by allowing one or more users to enter/input decisions regarding one or more of the component features (i.e., capabilities, functions, displays of the networked computing environment) through a multi-level decision hierarchy. It is to be understood that the description of the University setting provided above is merely illustrative and not intended to limit the scope and breadth of the current invention which may be employed with any networked computing environment.

In a first preferred exemplary embodiment of the current invention, a decision construct is provided as a computer readable set of instructions. The instructions may be embodied within any appropriate medium which allows for communication (i.e., downloading) of the instructions to a networked computing environment. The instructions may include a first command that designates permission levels and associates a user with each of the permission levels. A second command may further associate each of the permission levels with decision cells and a final command may allow the users to input their decisions into the decision cells. The users are therefore allowed to affect the various component features of the networked environment through entry of their decisions, thereby, allowing the user to control the networked environment.

In another preferred exemplary embodiment of the current invention, a networked computing system is provided that employs and is controlled by the decision construct. The system may include two or more computers communicatively coupled with one another. The decision construct of the current invention may then be loaded upon one of the computers and executed within the networked environment. The execution of the decision construct, thereby, allows a user interfacing with the computers to interface at a designated permission level with the construct to control the operation of the networked environment.

In another preferred exemplary embodiment of the current invention, a method is provided for configuring a networked computing environment. The method may include the step of implementing a decision construct upon the networked computing environment. Through a computer that is part of the networked computing environment a user may interface, at a designated permission level, with the decision construct and configure the networked environment.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a screen display of a networked computing environment, such as a WebTycho® learning platform, executing the decision construct in accordance with an exemplary embodiment of the current invention;

FIG. 2 is an illustration of a screen displayed by the networked computing environment executing the decision construct when a user selects a Conferences decision cell in accordance with an exemplary embodiment of the current invention;

FIG. 3 is an illustration of a screen displayed by the networked computing environment executing the decision construct when a user selects the New Tycho Technologies decision cell in accordance with an exemplary embodiment of the current invention;

FIG. 4 is an illustration of a screen displayed by the networked computing environment executing the decision construct when a user selects the Syllabus decision cell and then the Course Schedule decision cell in accordance with an exemplary embodiment of the current invention;

FIG. 5 is an illustration of a screen displayed by the networked computing environment executing the decision construct when a user selects the Course Content decision cell and then the Course Modules decision cell in accordance with an exemplary embodiment of the current invention;

FIG. 6 is an illustration of a screen displayed when a user with a Faculty permission level initially accesses a learning platform that is deploying an academic policy decision console in accordance with an exemplary embodiment of the present invention;

FIG. 7 is an illustration of a screen displayed when a user with a Teaching Assistant (“Ta”) permission level initially accesses a learning platform that is deploying an academic policy decision console in accordance with an exemplary embodiment of the present invention;

FIG. 8 is an illustration of a screen displayed when a user with a Student permission level initially accesses a learning platform that is deploying an academic policy decision console in accordance with an exemplary embodiment of the present invention;

FIG. 9 is an illustration of a screen displayed when a user with a Visitor permission level initially accesses a learning platform that is deploying an academic policy decision console in accordance with an exemplary embodiment of the present invention;

FIG. 10 is an illustration of an exemplary web screen displayed when the user with the Faculty permission level accesses a Faculty Center function of the learning platform that is deploying the academic policy decision console;

FIG. 11 is an illustration of an exemplary web screen displayed when the user with the teaching assistant permission level accesses a Faculty Center function of the learning platform that is deploying the academic policy decision console;

FIG. 12 is an illustration of an exemplary web screen displayed when the user with the Faculty permission level accesses the [Manage] Option function corresponding with the Syllabus function shown in FIG. 10;

FIG. 13 is an illustration of an exemplary web screen displayed when the user with the Faculty permission level accesses the Course Goals/Objectives function on the exemplary web screen shown in FIG. 12;

FIG. 14 is an illustration of an exemplary web screen displayed when the user with the Faculty permission level accesses the “Edit” function corresponding with the “Course Goals/Objectives” function on the exemplary web screen shown in FIG. 12;

FIG. 15 is an illustration of an exemplary web screen displayed when the user with the Faculty permission level accesses the “Course Description” function on the exemplary web screen shown in FIG. 12;

FIG. 16 is an illustration of an exemplary web screen displayed when the user with the Faculty permission level accesses the “Course Materials” function on the exemplary web screen shown in FIG. 12;

FIG. 17 is a block diagram representation of a sequence of computer executable commands for implementing the decision construct of the current invention upon a networked computing environment;

FIG. 18 is a block diagram representation of a method for configuring a networked computing environment in accordance with an exemplary embodiment of the current invention; and

FIG. 19 is an illustration of a networked computing environment capable of allowing the implementation of the decision construct throughout the network.

### DETAILED DESCRIPTION OF THE INVENTION

Reference will now be made in detail to the presently preferred embodiments of the invention, examples of which are illustrated in the accompanying drawings.

A decision construct of the current invention provides an adaptable configuration tool for configuring the decision making process over the operation of a networked computing environment. The decision construct is a configuration tool whereby the various decisions to be made for controlling all components of a networked computing environment may be associated with various users of the environment. As determined by the users associated permission level, the users are granted selective access to/given the ability to make those decisions by inputting the decision into a decision cell.

In a preferred embodiment, the decision construct provides its decision making configuration through the use of permission levels associated with decision cells. The permission levels of the current invention are an access authority tool, whereby, users associated with a particular permission level are given access to one or more decision cells through which they have the ability to input decisions regarding various components of the networked computing environment. The permission levels may be variously related to one another. In a preferred embodiment, the various permission levels relate to one another in a hierarchical manner, wherein certain permission levels are “higher” in the structure and therefore have priority and/or precedence over other “lower” permission levels. The decision cells are the user input locations wherein the users are allowed to enter their decisions into the construct. In operation, decisions input by users with higher permission level access to the networked computing environment will have priority over decisions input by user with lower permission level access. As previously stated, the components of the networked environment referred to include all inputs, outputs, directives, rules, features, aspects, displays, functional capabilities and various other factors as may be contemplated by those of ordinary skill in the art. Essentially, the use of the term component herein is a generic reference to any and all things within the networked computing environment that may be configured/controlled by user input.

It is contemplated that the decision construct may provide various decision making configurations as are contemplated by those of ordinary skill in the art. As stated above, the decision construct may provide a hierarchical decision making configuration for a networked computing environment wherein the decisions made and entered by higher permission levels cascade through the entire environment. For example, in a business setting the decision hierarchy and therefore the permission levels may include: 1. CEO, 2. President, 3. Vice President of a Division, 4. Department Head, 5. Manager, 6. Supervisor, 7. Floor Worker. In a University setting the decision hierarchy and therefore the permission levels may include: 1. Provost, 2. Dean, 3. Department, 4. Faculty, 5. Student. For each entity, the higher permission levels and their decision inputs into decision cells may take priority over the lower permission levels.

In a preferred embodiment, the decision construct allows the association of particular decision cells with particular permission levels. Thus, higher permission levels may enter decisions into the networked environment that may not be altered by lower permission levels. Thus, the lower levels may be given a read-only access to the information entered through the particular decision cell and displayed over the networked environment. However, the decision construct may also allow the higher permission levels to determine what type of access to the information the lower permission levels may have, such as Read-Only or Read-and-Write. It is contemplated that the decision construct, so configured, may provide an inheritance model whereby “permissions” or the right to make and input (“write”) a decision into a decision cell for display over the networked environment is passed down from the higher permission levels to the lower permission levels. For example, in the corporate setting the CEO permission level may allow them to make and enter decisions regarding the corporate hiring policy, corporate ethics, corporate culture, the mission statement and the like. The CEO permission level may also have the capability to “pass down” a decision to a lower level. For instance, the CEO may decide that the decision regarding corporate ethics may be made by the President permission level. The CEO permission level may be allowed to make this decision cell a Read/Write decision cell for the President permission level. The President permission level may then be allowed to input information into this decision cell regarding the corporate ethics component of the networked environment.

The permission levels of the decision construct may be given the authority to deny access to decision cells to lower permission levels. For instance, the CEO may have Read/Write access to the decision cell that allows for the input of the mission statement. The decision construct may also allow the President permission level Read/Write access to this decision cell. It is contemplated that the CEO permission level may be given a further decision cell that allows them to decide whether or not to limit the President permission level access to this decision cell to Read only.

It is to be understood that the configuration of permission levels (i.e., number, association with decision cells, association with users, and the like) may vary to accommodate the particular networked computing environment, reflecting a particular decision structure of an entity, within which the decision construct is being implemented. Therefore, the permission levels made available by the current invention may be determined by the internal decision structure of the entity that is being reflected through the networked computing environment. Alternatively, the configuration of the permission levels may be determined by various other factors, such as computing power, costs, consumer demand, and the like as may be contemplated.

The decision cells are the construct tools through which the user may input their decision into the networked computing environment. In a preferred embodiment, the decision cells are associated with a particular permission level and allow the user with that permission level to render a decision and have that decision be reflected throughout the networked environment. The decision cells may allow decisions for various components of the networked environment. For example, the provost permission level of a University may present to a user of the networked environment with this permission level a decision cell regarding academic policy. This decision cell may allow the user with provost permission level to input into the networked computing environment the academic policy of the University.

It is to be further understood that the information entered into the decision cell may vary, such as links, written description, audio, and other information as contemplated by those of ordinary skill in the art. The entry of information may be accomplished in various formats, such as manual, voice, or otherwise as contemplated. For example, the user may manually type in a link to a location communicatively coupled and accessible by the construct. For example, a user may enter a net/web address into a decision cell. Upon implementation within the networked computing environment, a user of the environment may be provided that link and upon selection may be sent to the location of the link.

The configuration of the decision cells corresponding to the permission levels and components of the networked environment affected may vary. For instance, the number of decision cells associated with a permission level and the number of components of the networked computing environment affected may vary. For instance, the provost permission level may have 4 associated decision cells and these decision cells may affect 4 different components of the networked environment. Alternatively, the number of associated decision cells may be less than or greater than 4 and may affect less than or greater than 4 different components. Similar variance of associated decision cells and affected components may be found amongst all the different permission levels of the current invention.

It is further contemplated that access to particular decision cells may or may not be granted only upon access to another decision cell. For instance, the decision cell for academic policy accessible by the provost permission level stated above may further include access to another decision cell whereby the provost permission level may determine the Read/Write access to be given to this cell by lower permission levels. The Read/Write determination may or may not be accessible until the academic policy decision cell is accessed.

The association of the various decision cells with various permissions levels may be determined by the decision structure present within the entity. For instance, a corporation may have various decision cells, such as ethics policy, hiring policy, daily work shifts and work shift assignments. The entity decision structure may dictate the following: 1. ethics policy is decided by the CEO, 2. hiring policy is decided by the President, 3. daily work shifts are decided by the Managers and 4. work shift assignments are decided by the Supervisor. The decision construct of the current invention may utilize this entity driven decision structure and implement the following within the networked computing environment: 1. ethics policy decision cell(s) is associated with the CEO permission level, 2. hiring policy decision cell(s) is associated with the President permission level, 3. daily work shifts decision cell(s) is associated with the Managers permission level and 4. work shift assignments decision cell(s) is associated with the Supervisor permission level. In the alternative, the higher permission levels that have access to all decision cells that are accessible to the permission levels below them, may be allowed to decide not to grant access to certain decision cells by the lower permission levels. For example, the President permission level may utilize their access to the daily work shifts decision cell(s) and designate that the daily work shift decision cell(s) are not accessible by the Manager permission level.

It is further contemplated that a review capability/feature may be included within the decision construct of the current invention. In a preferred embodiment, the review feature is an authority granted to a higher permission level than the permission level that is inputting information into a decision cell, wherein the higher permission level may be granted access to the decision cell after the information has been entered by the lower permission level and then have the capability to edit the information within that decision cell. The current invention may also allow the lower permission level to review the edits made by the higher permission level.

In another preferred embodiment, the current invention provides stops and/or blocks for the entry of information into the decision cells by associated permission levels. The stops, in effect, are deadlines for entry of information into the decision cells for each relevant permission level. It may often be the case that in a University networked computing environment, such as a virtual school, that classes have a set start date which is a final deadline. Dates prior to this final deadline may be provided as stops by the decision construct of the current invention and prevent any further input of information into a decision cell by one or more permission levels after that stop date. This is equally applicable in the business setting where a project may have a final due date and dates prior to that time may be provided as stops for entry of information into particular decision cells. The entry of information by the higher permission levels may require that stops be put in place to ensure that the information is available to the lower permission levels and others who may need this information in order to make informed decisions and enter proper information into the decision cells to which they have access. The construct may provide reminders for the users of the stops. The reminders may be variously configured and adapted to meet the needs of the networked computing environment upon which the construct is being executed.

It is to be understood that the construct of the current invention may allow editing of the configuration of the construct. The editing may allow a user to change the configuration of any of the permission levels, decision cells, and/or features/capabilities of the construct and/or networked computing environment. This may include editing in additional permission levels, decision cells, and/or features/capabilities or deleting capabilities. It may also include editing of the user association configuration to add or delete a user association with a particular permission level. It is also contemplated that the construct may be edited during the operation of the networked computing environment without necessarily impacting the operation of the networked computing environment while the editing is taking place from a user's point of view who is not accessing the editing capabilities. Thus, a user of the networked computing environment may or may not be provided an indication that an edit of the construct has or is taking place. The construct may include the capability to control the time of implementation of the edits throughout the networked computing environment, from real-time implementation to delayed implementation. It is further contemplated that edits may be received from different users having different permission levels. The construct may implement edits from different permission levels in a hierarchical/sequential manner or allow for various other implementation schedules as may be contemplated.

The implementation of the decisions entered into the decision cells throughout the networked computing environment may be variously configured through the decision construct. For example, decisions entered by a user with the highest permission level in the construct may be implemented throughout the networked computing environment in real-time or on a delayed basis. Decisions that are entered by users with lower permission levels may have their implementation delayed. The delay may be a simple time/date delay, based on entry of a decision by a higher permission level, or various other implementation schemas as may be contemplated. It is further contemplated that the construct may include “alerts” which provide an indication to users with various permission levels of actions that have been taken (i.e., decisions input) by various other users with different or similar permission levels. These alerts may include various visual and/or auditory indicators that may appear on a display apparatus (i.e., computer monitor) or be heard over an audio system linked to the networked computing environment.

The configurations of the alerts may vary to accommodate the needs of the particular networked computing environment. The indicators provided may include descriptive information of the event for which they are providing the alert, such as a written description of the action(s) taken. The indicators may also provide other information. For example, the indicators may provide a prompt for an action to be taken by the user receiving the alert. A higher permission level user may be prompted to review the action taken by a lower permission level to ensure compliance with the decision inputs from the higher permission level. Alternatively, a lower permission level may be prompted to review an action(s) taken by a higher permission level to ensure compliance with the decision inputs from the higher permission level. It is further contemplated that the alerts may be edited by a permission level before they are executed throughout the construct and networked environment. Therefore, the alerts may be utilized by a user to provide information to another user regarding the action taken by the first user.

It is contemplated that the decision construct of the current invention may include a user interface configuration and/or may be adaptable to utilize existing user interface configuration for the networked computing environment. The input of information into the decision cells of the construct may be allowed in various manners, such as manual entry, voice entry, and the like.

The construct may include encryption capabilities to provide secure access to various permission levels. Various encryption technologies as contemplated by those of ordinary skill in the art may be employed with the current invention. The encryption may be utilized to prevent unauthorized access to the permission levels, customize the capabilities of various users within a permission level, and the like. The encryption technology may allow certain permission levels to affect the encryption settings for various other permission levels.

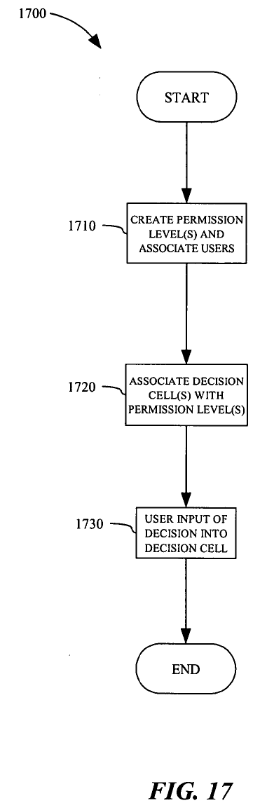

In a preferred embodiment of the present invention, computer executable instructions are provided in a format that may be communicated to a computing system and/or over a networked computing environment for providing adaptable control over the networked computing environment. In the current embodiment, a command sequence 1700 is show in FIG. 17. A first command 1710 may create one or more permission levels. These permission levels are further associated with one or more users of the networked computing environment. A second command 1720 associates one or more decision cells with the permission levels. A third command 1730 allows a user to input information into one or more of the one or more decision cells for which they have access based on their permission level association. The decision construct, by allowing the user access to various decision cells based on the user permission level association, allows the user to control the networked computing environment.

It is contemplated that the computer executable instructions allow for the editing (i.e., addition and/or deletion) of the configuration of the construct, wherein any aspect of the permission levels and decision cells may be changed. For example, an initial permission level configuration may include the creation of five (5) different permission levels. The current invention may allow the number of permission levels to be changed at a later time to fewer than or greater than five (5) permission levels. Another command may affect the users that are associated with the various permission levels. For example, a certain permission level may only allow three (3) users to be associated with it at any time. Another command may affect the decision cells that are associated with the various permission levels. For example, adding or deleting associations between the permission levels and decision cells. A still further command may control the “timing” of the implementation of the edits made. As described previously, the edits may be implemented anywhere from real-time to delayed, wherein the delays may be of any duration.

Another command may place encryption protection upon decision cells associated with certain permission levels. For instance, one user having a first permission level may have access to all decision cells associated with the first permission level while a second user with the first permission level may not have access to all associated decision cells. It is further contemplated that another command may provide for the creation of alerts by various users with certain permission levels. For example, a user with the higher permission level may be allowed to create alerts or decide not to for all subsequent permission levels for any decision input that they make. A command of the current invention may allow a permission level to place stops within the construct. Thus, a permission level with this authority can determine the timeline for entry of decisions into various decision cells by other permission levels. As described above, these stops may be based from a deadline date or other designation contemplated by the user. It is also contemplated that the construct may include an automatically executing command for any or all of the functions described above.

Another command of the current invention allows higher permission levels to “pass/push down” decision cell access to lower permission levels. For instance, the higher permission level may decide to allow a lower permission level to make one or more decisions that had previously been associated only with the higher permission level. In effect, the higher permission level is capable of associating various decision cells with lower permission levels. Another command may allow a user with a certain permission level to determine what type of access other user's with other permission levels may have to certain information. For instance, a higher permission level may allow lower permission levels a “Write” only access to certain information whereas for other information the lower permission levels may have a “Read/Write” access. It is further contemplated that another command may allow a higher permission level to allow or deny a first lower permission level the ability to associate various decision cells with a second lower permission level that is lower than the first lower permission level.

A still further command of the decision construct may allow certain permission levels to review the information entered into decision cells by other permission levels. This review command may also include an editing capability allowing the user to edit other user's work. It is contemplated that the review command may limit access to only certain permission levels or may be provided to all permission levels.

Allowing a user to input information into the decision cells of the construct may be accomplished through various user interfacing technologies, such as a graphical user interface, voice entry, and the like, and may be configured in various manners as contemplated by those of skill in the art. Therefore, one or multiple other commands may be included to implement such user interfacing technology. It is contemplated that the user interface may be provided by the construct and be capable of adapting to the networked computing environment or may be provided by the networked computing environment having various fields populated by decision cells of the construct. The one or multiple commands to implement a user interface may require input into decision cells of information by users with the appropriate permission levels. Alternatively, the decision construct may automatically execute one or multiple commands for the implementation of a user interface.

Another computer executable command and/or multiple commands may include the capability of editing/re-configuring the construct during operation of the networked computing environment. The re-configuration may affect any of the permission levels and decision cells associated with each permission level. One or multiple commands of the current invention may present, upon the editing of certain permission levels, the editing of various other functions that have also been associated with the permission level being edited, such as alerts, stops, encryption, and the like. It is further contemplated that another command may allow the editor of the permission level to review and edit all other decisions that have been made to date. For instance, during the editing of a higher permission level it may be noted that the association of a decision cell had been passed down to a lower permission level. The command may bring that previous decision to the attention of the editor and allow them to edit that decision.

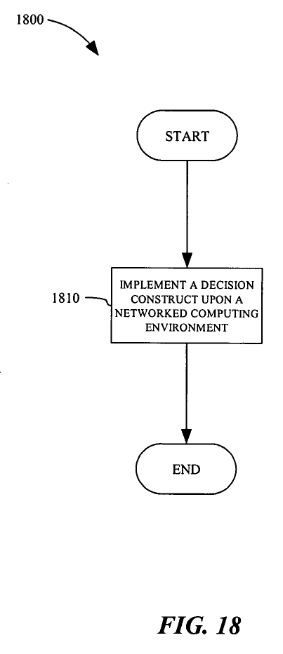

In a preferred embodiment of the invention, a method for configuring a networked computing environment is provided. In the current embodiment, the configuration method 1800 is shown in FIG. 18. The method includes a step 1810 of implementing a decision construct upon a networked computing environment. The decision construct allows a user to configure the networked computing environment through the input of decisions into decision cells associated with a permission level to which the user has been associated. Various other steps may be included in the configuration of the networked computing environment by the decision construct of the current invention. As described previously, the decision construct may be enabled to implement alert, stop, edit, review, by-pass and various other functions. The configuration may include the adapting of the construct to the decision structure of the entity that the networked environment is reflecting or the decision construct may provide the entire configuration. It is further contemplated that the decision construct may provide a user interface or may utilize the user interface of the networked computing environment by populating fields of the user interface with decision cells. The various other components and capabilities described throughout this description are to be understood to be an inherent part of the method of this current embodiment.

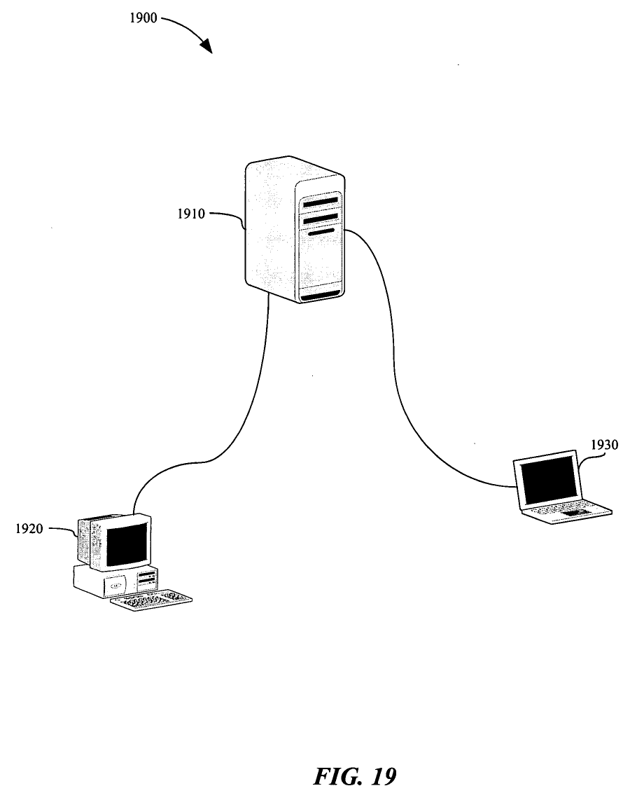

In a preferred embodiment of the invention, FIG. 19 provides a system 1900 including a server 1910 communicatively coupled with a first computer 1920 and a second computer 1930. It is contemplated that the system may include at least two networked computers that provide one or more users access to a networked computing environment (i.e., networked learning platform or online school) that is utilizing the decision construct (aka., APDC or DPC) of the current invention. The system may include a server computer networked with various other types of computers. It is further contemplated that the networked computers may be various computer structures/configurations as contemplated by those of skill in the art. The system described herein is exemplary and not intended to limit the scope and breadth of the current invention. By way of an alternative example, a system may including a first computer networked (communicatively coupled) with a second computer, wherein the network allows the computers access to a learning platform utilizing the APDC. The computers may be of standard configuration or customized as contemplated by those of skill in the art. In a preferred embodiment, the first computer may be a server computer that is hosting the learning platform including the APDC and is communicatively coupled with one or more individual user personal computers (PC). It is contemplated that the learning platform may be hosted upon one computing system and the ADPC may be deployed from a secondary computing system onto the platform. Further, it is contemplated that networked computers or multiple computer networks may be networked in order to provide the learning platform, and the ADPC may be implemented upon the platform through one or more of the networked computing environments. Further, the type of computer may vary, such as a PC, server, handhelds, tablets, and the like. Also, the networked computing environments may be implemented over a LAN, WAN, Intranet, the Internet, and the like, wherein computers are communicatively coupled to another individual computer or another networked computing environment over the one or more networks.

It is to be understood that the current invention may be implemented using any one of various networked environment standards. For example, the networked environment may preferably implement industry promulgated architecture standards, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and other industry promulgated architecture standards as may be contemplated by those of ordinary skill in the art.

A method of customizing a learning technology may include a step of providing a learning platform implementing the decision construct of the current invention over a networked computing environment. The construct employed as a configuration tool/control mechanism for the learning platform. The construct may allow the creation of one or more levels (e.g., permission levels) associated with one or more users of the system, such as independent permission levels for a provost, a dean, a department chair, a course director, and a faculty member. The permission levels may allow differentiation amongst the users of the system as to decisions, made through decision cells (described below), that each user(s) is allowed access to and the functional capabilities of the learning platform that each user(s) is allowed to affect. The decision cells are associated with a permission level and may allow the user to make and enter a decision into the decision construct which may effect a change within the learning platform. As previously described and as will be further described herein, the number and types of decision cells made available to the different permission levels may vary and may be determined by the decision construct which allows for the customization of permission levels and thereby the customization of the management of the learning platform. In the example provided above, the decision construct allows the learning platform to be customized to reflect the policy of the University.

Without intending to limit the scope of the present invention, the application and capabilities provided by the decision construct within a learning platform/networked computing environment may be better understood through use of a concrete example. The following description is based upon an online learning environment or online university, however, the decision construct may be just as readily applied within various other networked computing environments. A Syllabus of a learning platform, which may act as a user interface tool for the networked computing environment, that is implementing the decision construct, is described below.

In the current embodiment, the Syllabus is configured to provide information to users, such as written description(s) and audio feedback, and may include numerous additional functional capabilities. The decision construct of the current invention may allow a user associated with a particular permission level to control the information and functional capabilities provided or displayed through the Syllabus. The construct may control or limit access to decision cells (capabilities), which may affect the Syllabus, to certain permission levels. Alternatively, the construct may limit access to decision cells that affect the content of the Syllabus to a single permission level and allow that permission level to decide which, if any, decision cells will be accessed by other permission levels. For example, the decision construct may include numerous decision cells requiring the input of decisions in order to configure/create/generate the syllabus. The construct may control the association of these decision cells with one or more permission levels through various manners, as previously described. Thus, the information and/or functional capabilities (decision cells) provided may be a function of decisions entered within decision cells by certain permission levels. It is further contemplated that the construct may allow for further editing of the Syllabus by various other permission levels than those allowed to configure/create/generate the syllabus. For instance, the functional capabilities provided by the Syllabus may include access to decision cells that allow users associated with certain permission levels to make decisions regarding the Syllabus and affect changes to the Syllabus. It is contemplated that within the decision construct, as described above, the higher permission levels may or may not allow access to various decision cells to lower permission levels. This may have the effect of limiting the information and functional capabilities provided through the Syllabus to these lower permission levels as they may not, for example, be allowed access to certain decision cells. It is further contemplated that the access to decision cells may vary amongst the multiple permission levels of the decision construct. In this manner, the decision construct may control the networked computing environment by controlling the configuration of the Syllabus and other user interfaces within a networked computing environment and therefore control the decision cells (i.e., information and functional capabilities) provided to different users with different permission levels.

It is to be understood that any embodiment of a user interface within a networked computing environment, such as the Syllabus of the learning platform, may include various functions/decision cells. In the current embodiment, the Syllabus includes and displays a “Faculty Center”, “Course Content”, “Reserved Readings”, “Conferences”, “Study Groups”, “Webliography”, “All Workbooks”, “Portfolio”, “Gradebook”, “Chat Room”, and “Class Members” functions. Each function may provide additional decision cells (i.e., additional functional capabilities) and/or additional information, which may or may not be found or accessed through the other functions. The decision construct of the current invention may control access to any of these functions and their information and functional capabilities through the association of the decision cells with one or more permission levels. The user accessing the networked computing environment through the Syllabus is provided access to the various decision cells based upon the user's associated permission level.

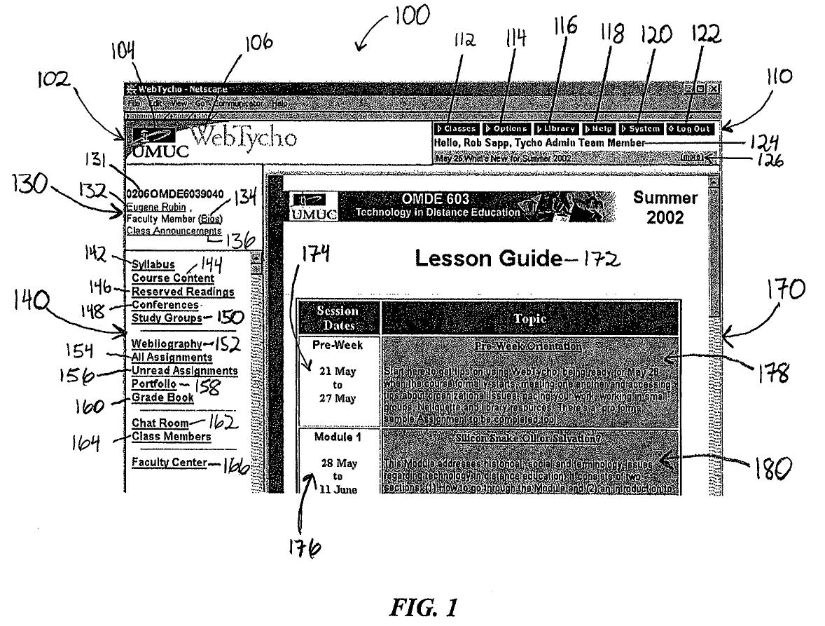

In the current embodiment, the Syllabus of the networked computing environment and other exemplary functions are described below and illustrated in FIGS. 1-16. One of ordinary skill in the art will recognize that the capabilities provided by the decision construct through the “Syllabus”, as will be further described below, may be provided through one or more other user interface configurations that may be enabled upon any networked computing environment. The decision construct may execute its functional control through existing user interface configuration provided by the networked computing environment. Alternatively, the decision construct may provide a user interface configuration to a networked computing environment through which control of the environment may be effected.

The decision construct (aka., Academic Policy Decision Console (APDC) or Decision Policy Console (DPC)) may allow for the creation and/or management/administration of a networked computing environment, such as the learning platform described herein, by the following process utilizing an organizational construct that reflects the way in which the institution creates academic policy related to educational technology (e.g., learning platform):
1. Provide a decision construct that reflects the policy making level(s) at the institution. This may include vertical and horizontal delineations. The relationship between a school and its departments or a business division and its departments are examples of a vertical delineation. The relationship between multiple departments is an example of a horizontal delineation.
2. Identify and label the “cells” (decision cells) in the decision construct where decisions are made.
3. Select the functions in the learning technology that will be governed by the decision construct, e.g., syllabus, conferencing, gradebook, other functions that are present within the networked computing environment.
4. Determine and install the nature of the decisions for each function at each level.
5. Beginning at the top, have the appropriate policy makers indicate their decisions by completing the items (input of decisions into decision cells) in the decision construct.
6. Deploy the completed decision construct to the learning management system.

### EXAMPLE 1

Example 1 is a highly centralized 4 year liberal arts college with all academic programs residing within a single school under a single Dean. The Dean and her staff create a decision construct (aka., APDC) that reflects three levels: executive academic administration (Dean), department chairs, and faculty. The Dean permission level pushes most rights and privileges (decision making authority/access to decision cells) to the faculty permission level with the exception of school-wide academic policies and schedules, which are identified as read only to subsequent/lower levels. Some department chairs build standardized syllabi for courses, require specific grading standards, and prescribe a look-and-feel for classes under their domain. Thus, the department chair permission level grants access to those decision cells that create and control such functions. The decision construct may allow the department chair permission level to allow the faculty members/faculty permission level users to have more autonomy and may leave many of these decisions up to the faculty member.

### EXAMPLE 2

Example 2 is a decentralized research-driven university where the provost has an active role in determining executive academic policy. The provost and his staff begin by creating a decision construct (aka., APDC) that reflects five levels in the institution: executive academic administration (provost), senior academic administration (deans), department chairs, course directors and faculty. The provost provides an annual academic calendar and a university-wide code of ethics that is deployed across the learning environment/enterprise. For the school of arts and sciences and the school of engineering, the provost elects to provide grading requirements which are reflected in the Gradebook. For the schools of medicine and law, the provost defers all other decisions to the deans. The construct allows the provost to pass down their access to decision cells, such as to those which determine grading requirements, to these subsequent/lower permission levels.

The dean of the school of arts and sciences determines that all classrooms must have an area for school-wide announcements and access to an online writing center. The dean for the school of engineering has chosen the APA citation standard and that decision is reflected in every online classroom. The dean of the school of medicine determines that almost all academic decisions be deferred to the department chairs. The dean of the law school requires that all students be provided with access to the online law library within their classrooms and that advising may access each student's calendar for scheduling sessions. Subsequent decisions by the department chairs, course directors and faculty reflect the complexity of the process in which academic policy is determined and the need for the decision construct.

Case Study: The World Wide Syllabus. A syllabus may be used for an online course to relay a variety of important information. A syllabus system using the decision construct of the current invention may support its schools and affiliates with a hierarchically structured system. This may allow for ease of creation and maintenance and enforcing a certain amount of academic consistency. As explained above, the level of access to the syllabus may be controlled by the decision construct through the different permission levels. The different permission levels may be configured to include any number of decision cells for decisions to be made that may affect the syllabus and then have those decisions deployed on the learning platform through the syllabus. The decision construct may allow one or more permission levels to decide what other permission level(s) may or may not decide, thereby controlling who may effect change to the syllabus function either by changing the information displayed or functional capabilities that may be accessed.

In the current embodiment, the decision construct reflects three permission levels: (1) executive academic administration (Dean), (2) department chairs, and (3) faculty. The decision construct also reflects three divisions within the university: (1) United States, (2) Europe, and (3) Asia. Through the decision construct the Dean or her designee can dictate the level of customization allowed for each section at subsequent levels. This permissions editor capability may allow the Dean to determine which users and which permissions levels may have access to which decision cells that may affect changes to the functions and information made available through the learning platform. Thus, the Dean permission level may determine the nature of the decision construct for other permission levels. For example, the user with administration permission level may determine and implement a decision construct for the other permission levels that does not allow the other permission levels to make any decisions with regards to a particular function of the learning platform or may allow different permission levels to make various decisions, as will be further described below.

The permissions editor may allow a user to affect limited or broad changes to the functions and information of the learning platform through the construct of the current invention. For instance, a user with an administration permission level may be able to access the decision construct for the Syllabus and be presented with any number of decision cells for entry of decisions that may or must be made by a user with this permission level. The number of decisions and/or decision cells may vary and the user with this permission level may be allowed to affect change to a limited number of functions and information of the learning platform or may be allowed to affect change to all functions and information.

The decision construct provides a model of the business process of the university. It is to be understood that the decision construct of the current invention is capable of providing a model of the business process for businesses and other institutions. For instance, below the administration level identified above there may be two or more subsequent levels depending on the model of the business process of the university. By way of example, there may be four total levels including the final class level that the student and instructor see. Each level may include a permissions editor allowing the user at that level to affect, in some manner, the syllabus settings. However, the permissions are inherited from above and the final syllabus is an aggregate of all settings and changes down the line.

This level of flexibility may be useful to model the wide variety of classes offered by various institutions. This may be particularly useful when dealing with a complicated hierarchical structure, such as that found at many universities, which may have one or more divisions (Stateside, Europe and Asia), wherein each division may have one or more departments (e.g., MATH, ENGL, etc.) and then within each division and department there may be one or more classes.

Syllabus Feature List

View/Edit/Create/Delete Syllabus Template.

View/Edit/Create/Delete Model Syllabus.

View/Edit/Create/Delete Syllabus Item.

View/Edit Class Syllabus.

Version on Edit.

Utilize an editor that supports cut & paste from MS Word.

Displayable Revision History.

Ability to push down edits.

Search at the Model and Class layers.

Releasable Flag (perhaps at multiple levels).

Find all Classes using a syllabus (flag active/inactive).

Show all syllabi (with some component-simple queries).

Reorder Syllabus Items on a template.

Set permission on items.

Support a fine grained security model for admin users.

Allow separate look and feel for each division.

User specific “templates” for a section. Make it easy to roll forward without having to import.

Syllabus Requirements

The ability to create a syllabus template that completely describes the sections of a syllabus and the downstream permissions (access to decision cells) associated with each syllabus item.

The ability to create and manage multiple templates to reflect the differing needs of the different departments, Grad School, SUS and other organizations that might use the system.

The ability to store, edit and retrieve model syllabi. A model syllabus is based on a template and may contain the base text for a given course in that school. There may be one model per course and it may be considered the authoritative base from which actual class syllabi will be derived when a class is created.

The ability for subunits (the overseas divisions in this context) to customize certain sections of the model syllabus to reflect local needs.

The ability to require departmental level review of a syllabus before student access.

The ability for faculty members to make edits to the appropriate fields.

The ability for faculty members to import their edits from previous semesters.

The ability to take registration data from various external registration systems for use in the class syllabi creation process.

Candidate Use Cases. For the sake of organization, the use cases are broken up by level (permission level(s)). There are 4 types of levels:

1. The top level is the administrative level. This is where master syllabus templates are created, the numbers of intermediate levels are defined, the downstream permissions are set, the decisions to be made by each level may be defined, and the like.

2. The next level is the master level where the Master Syllabi is typically created and the course schedules are defined.

3. There are an arbitrary (possibly zero) number of intermediate levels (e.g., division, department) where further refinements to the syllabi may occur.

4. The course level (what the student and instructor actually work with).

Administrative Level:

View a Master Syllabus Template.

Create a Master Syllabus Template.

Edit a Master Syllabus Template.

Create Levels.

Manage Level Settings.

Master Level:

View a Master Syllabus.

Manage a Master Syllabus.

Create a Master Syllabus.

Edit/Create a Course Schedule.

Publish a Master Schedule.

Edit a Master Syllabus.

Course Level:

Manage a Course Syllabus.

View Course Syllabus.

Create a Course Syllabus.

Publish a Course Schedule.

Intermediate Level(s):

View Level Syllabi.

Create Course Listings.

Manage a Level Syllabus.

Publish a Level Syllabus.

It is to be understood that the number of permission levels may vary and the number of decisions allowed to be made at each permission level may vary. The levels and permitted decisions identified above are exemplary and not intended to limit the scope of the present invention. Table 1 (below) is an illustrative representation of the permission levels and the decisions each level is allowed to make as identified above.

TABLE 1

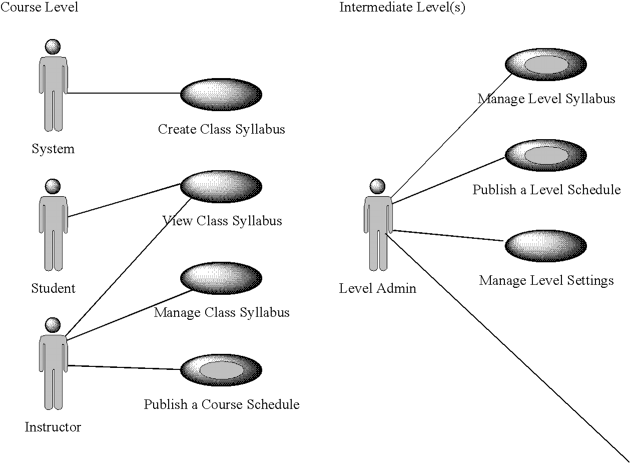

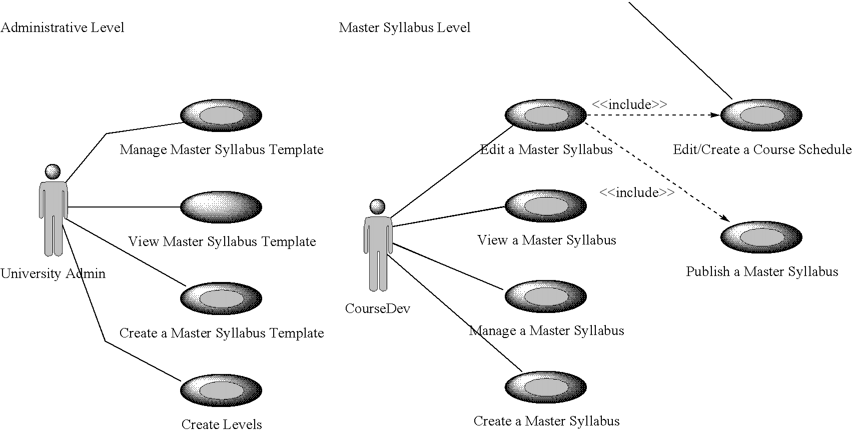

View Master Syllabi Use Case Description (Table 2). The View Master Syllabi use case describes how the system may display the master syllabi for a course. This may be considered a “student” view of the syllabus. This includes navigation to the correct syllabus.

Actors

1. Primary Actor—A user

2. Secondary Actor—The System

Preconditions

1. The user is logged in.

2. The user has master syllabus level access (permission).

1. Normal Flow of Events—View a Master Syllabus

1.1. The system presents the user with an alphabetic listing of the existing master syllabi.

1.2. The user selects a Master Syllabus from the list presented.

1.3. The user is presented with the selected syllabus.

1.4. The use case ends.

2. Alternative Flow of Events—Filtered View of Syllabi

2.1. The system presents the user with an alphabetic listing of the existing master syllabi.

2.2. The user selects a course prefix from the filter.

2.3. The system reduces the display list to just those master syllabi with that course prefix.

2.4. The user selects a Master Syllabus from the list presented.

2.5. The user is presented with the selected syllabus.

2.6. The use case ends.

3. Exception Flow of Events—The Action Results in an Error

3.1. The system logs the error.

3.2. A brief error message is displayed to the user.

3.3 The user is returned to the list of master syllabi.

3.3. The use case ends.

TABLE 2

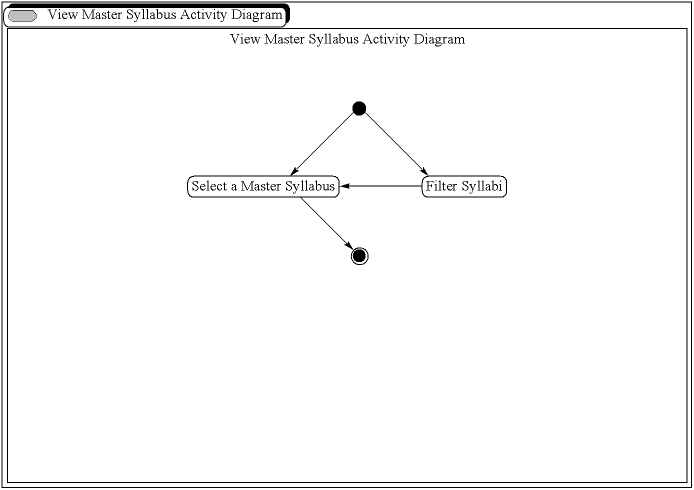

Manage Master Syllabi Use Case (Table 3).

Description. The Manage Master Syllabi use case describes the functions a user with the appropriate permission level may perform on a master syllabus from the list of all master syllabi.

Actors

1. Primary Actor—A user

2. Secondary Actor—The System

Preconditions

1. The user is logged in (with master syllabus level access).

1. Normal Flow of Events—Create a master syllabus

1.1. The user selects the Create Master Syllabus feature from the navigation options.

1.2. The user is asked for the Course ID for the new master syllabus.

1.3. The user selects Create Master Syllabus from the navigation options.

1.4. The system creates a new master syllabus for the indicated course based on the current master syllabus template.

1.5. Include the Edit a Master Syllabus use case here.

1.6. The use case ends.

2. Alternative Flow of Events—Edit a Master Syllabus

2.1. The user selects the Edit feature from the navigation options associated with a given master syllabus.

2.2. Include the Edit a Master Syllabus use case here.

2.3. The use case ends.

3. Alternative Flow of Events—Delete a Master Syllabus

3.1. The user selects the Delete feature from the navigation options associated with a given master syllabus.

3.2. The user is presented with a confirmation dialog.

3.3. The user selects Yes from the options.

3.4. The system deletes the syllabus.

3.5. The system updates the view.

3.6. The use case ends.

Nonfunctional Requirements

1. Business Rules—The website is never really deleted. Just marked deleted and removed from user view.

2. Usability Requirements—None.

3. Data Definitions—None.

4. Deployment Constraints—None

TABLE 3

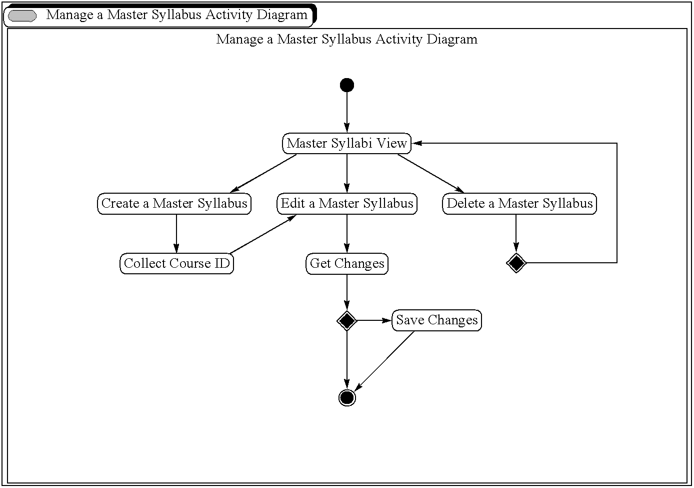

Edit a Master Syllabus (Table 4).

Description

The edit a Master Syllabus use case describes how the system may allow the user with proper permission level to change (edit) and enter the information for a master syllabus. This use case is both stand alone and included in the Create a Master Syllabus use case.

Actors

1. Primary Actor—A user

2. Secondary Actor—The System

Preconditions

1. The user is logged in (with Master Syllabus level access).

2. The user has selected the Edit link associated with a particular master syllabus or has entered a Course ID in the process of creating a new Master Syllabus.

1. Normal Flow of Events—Edit a Section of a Master Syllabus

1.1. The system presents the user with a read mode display of the master syllabus and a series of buttons/links, one for each section of the syllabus.

1.2. The user selects a section to edit.

1.3. The system presents the user with an editor that contains any previously added information.

1.4. The user makes any changes they desire and selects Save Changes (or Cancel).

1.5. The system saves (or discards) any changes.

1.6. The user is returned to the previous read mode screen (that has been updated to reflect heir changes.)

2. Normal Flow of Events—Publish a Master Syllabus

2.1. The system presents the user with a read mode display of the master syllabus.

2.2. The user selects Publish Syllabus from the navigation options.

2.3. The system presents the syllabus in a read mode view and a button.

2.4. The user selects Publish (or Cancel).

2.5. The system pushes the syllabus to the next lower level.

2.6. The system displays the results of the operation and a link to the main index view.

2.7. The use case ends.

3. Normal Flow of Events—Create a Schedule for a Master Syllabus

3.1. The system presents the user with a form that allows them to select which columns and heading to use (from the master syllabus template) and the number of units (e.g., weeks) in the schedule.

3.2. The user makes the relevant selections presses Create Schedule (or Cancel).

3.3. The system saves (or discards) any changes.

3.4. Include the Edit Course Schedule use case here.

3.5. The use case ends.

4. Exception Flow of Events—The action results in an error

4.1. The system logs the error.

4.2. A brief error message is displayed to the user.

4.3. The use case ends.

TABLE 4

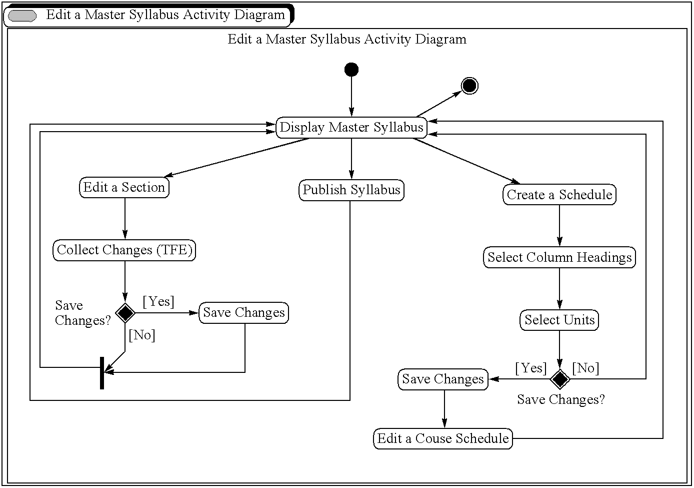

Edit/Create a Class Schedule for a Master Syllabus (included in Edit a Master Syllabus) (Table 5).

Description

The Edit a Class Schedule use case describes how the system allows the user with the proper permission level to edit the information for a class schedule in a master syllabus. This includes creating a new schedule as it is a trivial instance of edit.

Actors

1. Primary Actor—A user

2. Secondary Actor—The System

Preconditions

1. The user is logged in with Master Syllabus access.

2. The user has selected a master Syllabus to edit.

3. The user has selected an associated schedule to edit OR has just created a new schedule.

1. Normal Flow of Events—Edit a Unit

1.1. The system presents the user with a UI that shows the schedule in tabular form.

1.2. Each unit has an associated Edit and Delete link.

1.3. The user selects Edit.

1.4. The system presents the row data in an editable form.

1.5. The user makes any changes and selects Save (or Cancel).

1.6. The system saves (or discards) any changes.

1.7. The user is returned to the (updated) View.

1.8. The use case ends.

2. Normal Flow of Events—Delete a Unit

2.1. The system presents the user with a UI that shows the schedule in tabular form.

2.2. Each unit has an associated Edit and Delete link.

2.3. The user selects Delete.

2.4. The System presents a confirmation box.

2.5. The user selects Yes.

2.6. The system saves the change.

2.7. The View is updated.

2.8. The use case ends.

3. Exception Flow of Events—The Action Results in an Error

3.1. The system logs the error.

3.2. A brief error message is displayed to the user.

3.3. The use case ends.

TABLE 5

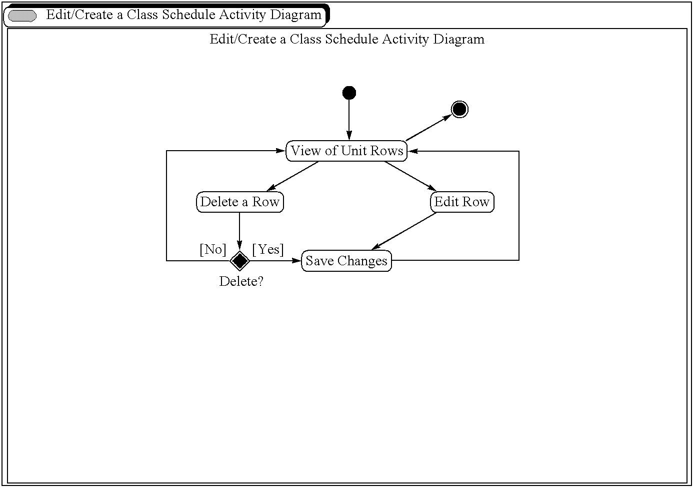

View Published Level Syllabi (Table 6).

Description

The View Published Level Syllabi allows a user with that level of access to see a list of syllabi that have been published down from the next higher level and status information about each one. There is also a filtering option to reduce the view to a manageable size.

Actors

1. Primary Actor—A user

2. Secondary Actor—The System

Preconditions

1. The user is logged in and has level access.

1. Normal Flow of Events—View Published Syllabi

1.1. The system presents the user with a list of the published syllabi.

1.2. The use case ends.

2. Alternate Flow of Events—View Level Syllabi

2.1. The system presents the user with a list of all syllabi available to that level.

2.3. The use case ends.

3. Exception Flow of Events—The action results in an error

3.1. The system logs the error.

3.2. A brief error message is displayed to the user.

3.3. The use case ends.

TABLE 6

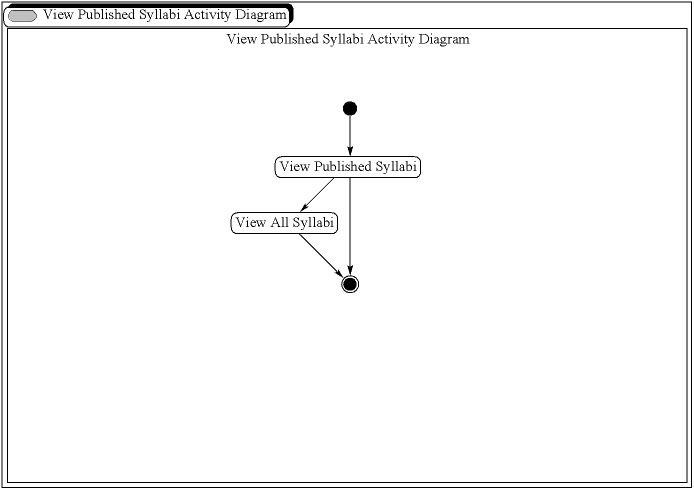

Manage a Level Syllabus (Table 7).

Description

The Manage Level Syllabus use case describes how the user works with the syllabi at their level to modify the fields and edit/create schedules. It also shows how they publish them down to the next lower level.

Actors

1. Primary Actor—A user

2. Secondary Actor—The System

Preconditions

1. The user is logged in.

2. The user has elected to enter a classroom.

3. The user has selected Manage Webliography from the navigation options.

4. The user has selected (Re)Sequence Websites from the navigation options.

1. Normal Flow of Events—Edit a Section of a Level Syllabus

1.1. The system presents the user with a read mode display of the syllabus and a series of buttons/links, one for each section of the syllabus.

1.2. The user selects a section to edit.

1.3. The system presents the user with an editor that contains any previously added information.

1.4. The user makes any changes they desire and selects Save Changes (or Cancel).

1.5. The system saves (or discards) any changes.

1.6. The user is returned to the previous read mode screen (that has been updated to reflect their changes.)

2. Normal Flow of Events—Publish a Level Syllabus

2.1. The system presents the user with a read mode display of the master syllabus.

2.2. The user selects Publish Syllabus from the navigation options.

2.3. The system presents the syllabus in a read mode view and a button.

2.4. The user selects Publish (or Cancel).

2.5. The system pushes the syllabus to the next lower level.

2.6. The system displays the results of the operation and a link to the main index view.

2.7. The use case ends.

3. Normal Flow of Events—Create a Schedule for a Level Syllabus

3.1. The system presents the user with a form that allows them to select which columns and heading to use (from the master syllabus template) and the number of units (e.g., weeks) in the schedule.

3.2. The user makes the relevant selections presses Create Schedule (or Cancel).

3.3. The system saves (or discards) any changes.

3.4. Include the Edit Course Schedule use case here.

3.5. The use case ends.

4. Exception Flow of Events—The Action Results in an Error

4.1. The system logs the error.

4.2. A brief error message is displayed to the user.

4.3. The use case ends.

TABLE 7

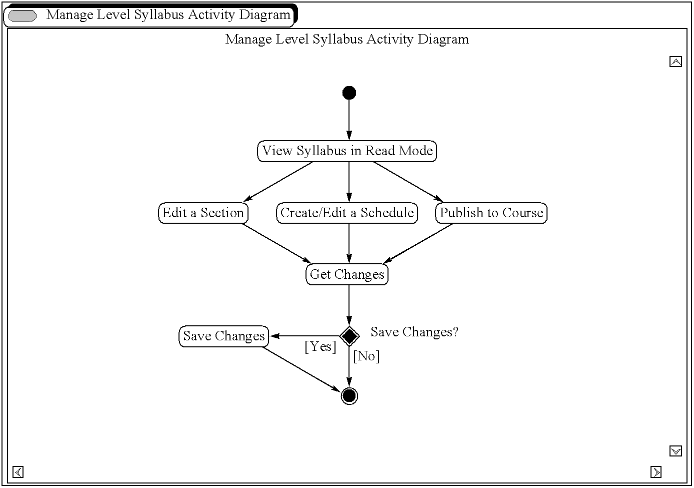

Data Definition (Table 8).

TABLE 8

| | | | | |
|---|---|---|---|---|
| 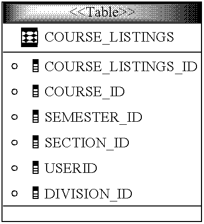 | 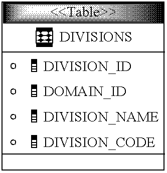 | 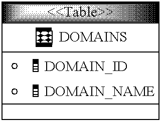 | 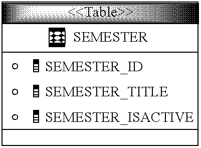 | 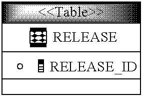 |

| | |
|---|---|
| 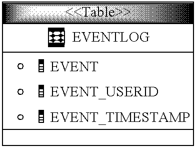 | 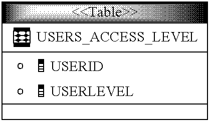 |

| | | |
|---|---|---|
| 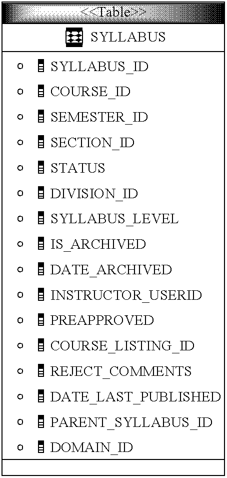 | 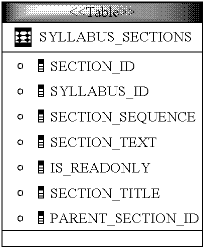 | 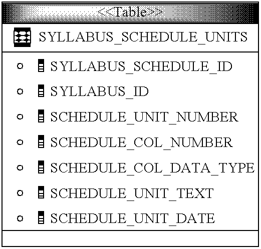 |

| | | |
|---|---|---|
| 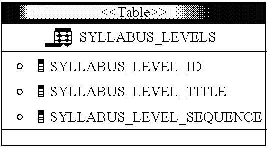 | 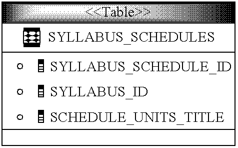 | 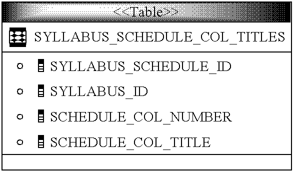 |

| | |
|---|---|
| 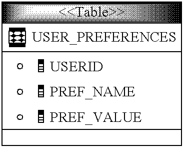 | 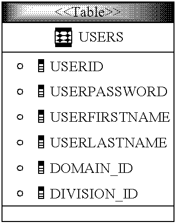 |

The current invention may be implemented upon various networked computing environments, such as a net/web-based learning platform. In a preferred embodiment, the current invention is implemented upon a learning platform enabled over the Internet, such as the WebTycho® system. While the current invention will be described as implemented within the WebTycho® system, it is to be understood that the APDC may be deployed/implemented on alternative learning platforms without departing from the scope and spirit of the present invention.

WebTycho® is a proven learning platform that provides comprehensive academic and administrative functions to students worldwide. Designed to provide complete course delivery at a distance or as an enhancement to face-to-face classrooms, WebTycho® consists of dozens of inter-related applications and technologies based directly on the needs of faculty and students.

In a preferred embodiment, FIG. 1 is an exemplary display screen 100 that may be provided through the WebTycho® networked computing environment. The display may be various configured and in the current embodiment the display is provided in multiple sections for the grouping and display of relevant and related information and functional capabilities. It is to be understood that the various sections may be further sub-divided into sub-sections to provide the information and capabilities of the current invention. In the current embodiment, section 102 includes a display of the institution name 104 and name of the networked computing environment 106. A section 110 includes a display of various decision cells/functional capabilities that include Classes 112, Options 114, Library 116, Help 118, System 120, and Log Out 122. Section 110 further includes a “Greetings” area 124, which may be personalized for the particular user. Section 110 also includes a “What's New” area 126, which may allow the user to access further information through another decision cell/functional capability.

A section 130 includes various descriptive information regarding the course and the faculty and further includes decision cell 131 which is the class identifier and decision cell 132 regarding an identified individual. It also includes a decision cell 134 allowing a user to access the bio of a faculty member. This may grant access to the faculty teaching the course or to faculty in a department or faculty school-wide. Decision cell 136 allows the user to access class announcements that may be relevant to the particular course. Section 140 provides various functional capabilities to the user that include Syllabus 142 and Course Content 144 for instructors to deliver material; Assignment Folder, that includes All Assignments 154 and Unread Assignments 156, for students to hand in personal work; Gradebook 160 for instructors to deliver grades of assignments and other materials to the student(s), Conferencing 148 for class-wide asynchronous discussions; Study Groups 150 for small group work; and Chat Room 162 for real-time interaction. Supporting functions include Reserved Readings 146 (faculty-selected, read-only, copyrighted material), Webliography 152 (potpourri of websites posted by all class members), Portfolio 158 (documentation of individual activity), Class Members 164 (e-mail directory), robust text creation tools, and Faculty Center 166 (creation tools for faculty only.) Beyond their basic function, these sophisticated features allow varying degrees of customization and complexity.

Section 170 provides further descriptive information that may be related to subjects regarding various topics from school-wide issues to individual student issues. IN the current embodiment, section 170 is displaying relevant course information in a “Lesson Guide” 172 format. The Lesson Guide 172 is shown presenting the information in a date driven manner wherein it starts with a “Pre-Week” 174 sub-section of section 170 and continues with a “Module 1” 176 sub-section. Each of these sub-sections may include further division whereby additional information is provided as shown by sub-sub-sections 178 and 180. It is further contemplated that the display 100, through the various sections, such as section 140 and 170, may present information access through a “scroll-down” manner whereby the sections present further information that may be accessed by the user through scrolling down through the particular sections. It is to be understood that the display shown in FIG. 1 is exemplary and the capabilities shown and provided are examples of those that may be employed and are known to those of skill in the art and are not intended to limit the scope of the present invention.

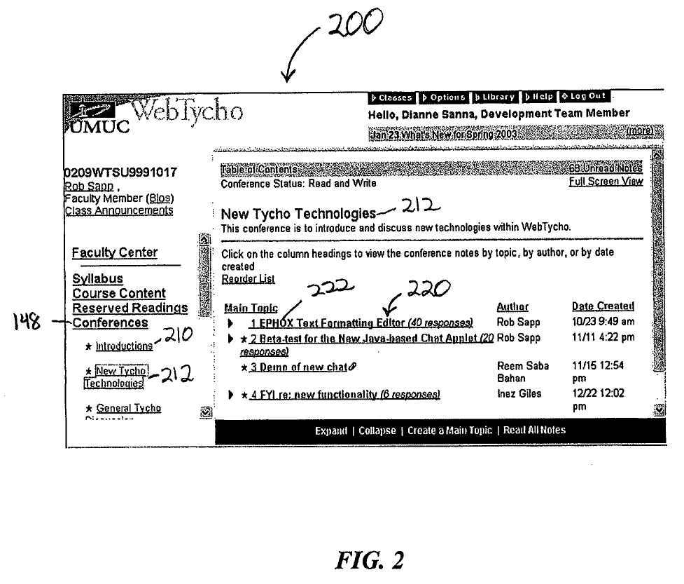

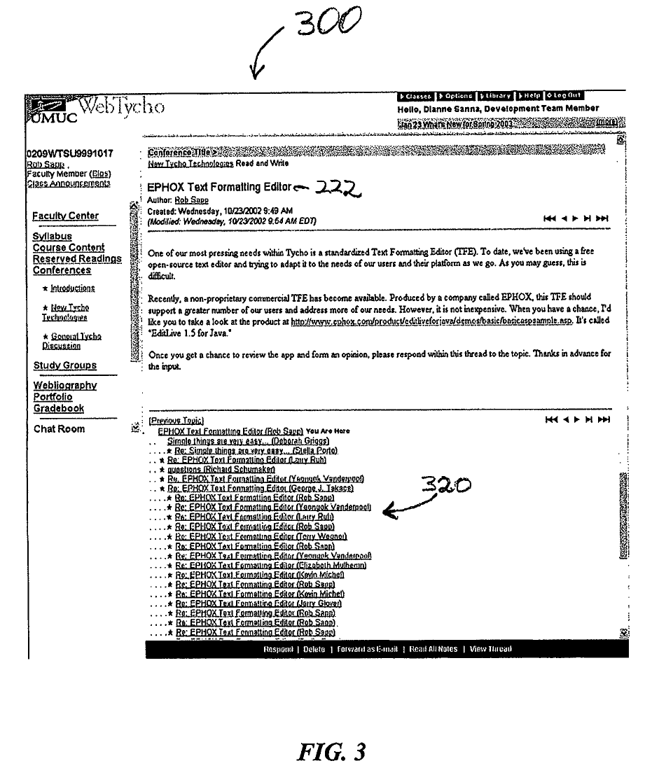

Conferences. FIGS. 2 and 3 provide exemplary illustration of locations within the current embodiment of a networked computing environment where class discussions and hearty exchanges take place, in writing, over the course of days. As shown in screen 200, conferences are threaded, written communications that allow all members of the group to read, receive, and write messages in a secure, virtual space not accessible to those who are not members of the class. Particular conferences may be accessed through the Conferences 148 function and then selected from a list of available conferences, such as “Introductions” 210 and “New Tycho Technologies” 212. In the current embodiment, section 170 of the screen 200 displays that the New Tycho Technologies 212 conference has been selected. Section 170 provides a discussion display 220 of the discussions that may have taken place regarding this subject. Various information, such as the author, time and date, and the like, of the person who created the particular discussion, such as EPHOX 222, may also be included within the thread display 220 sub-section of section 170 of screen 200.

Files may be attached to conference notes. Faculty members and others with permission may create conferences. Faculty and others with appropriate permission may set the status for each conference to Read and Write, Read Only, or Respond Only, and they may change the status at any time. The appropriate permission levels, such as Faculty, may reorder the conference list so keep in mind that the student view of the Class Menu may change from time to time. Graphical colored stars (e.g., red stars) indicate notes which a user may not have yet read and allow them to quickly sort for new postings.

By posting notes in an ordered, sequential manner, the chronology and logic of a discussion can be easily followed at any time. Threading is achieved through the use of Main Topics and Responses. The Topic Thread is displayed at the end of each conference note with the most recently added note at the bottom of the list. The construct of the current invention may vary the level of Threads that are displayed and/or available for display. The Threads may be reordered, individual Threads may be removed, and various other editing of the Threads may take place within the construct by a user with the appropriate permission level.

Display 300, shown in FIG. 3, is a display of the thread headings 320, identifying individual input to the discussion, within the discussion 222 of EPHOX. It is contemplated that the threads may include more or less identifying information. For example, in the current display each of the threads are followed by an indication of the author of the particular thread. Additional information such as the time and date of the creation of the individual threads may also be included. Various other display options and capabilities as are generally known to those of skill in the art may be provided by the current invention.

It is further contemplated that the construct of the current invention may allow the Conferences and the information contained within each Conference to be manipulated. For instance, the current invention may allow the Conferences to be searched. The construct may provide a search engine or may allow the execution of other search engine applications. The construct through its use of permission levels may limit the users who are able to perform a search of Conferences within the construct. The construct may further limit the scope of searching that is available to a user with permission to search. The construct may provide for and/or allow the storage of Conferences on a temporary or permanent basis. The storage of such information may be automatically performed by the construct or require input of a decision to store a Conference into a decision cell by a user with the appropriate permission level. The technologies and applications employed to deliver such storage and searching capabilities may vary as contemplated by those of ordinary skill in the art.

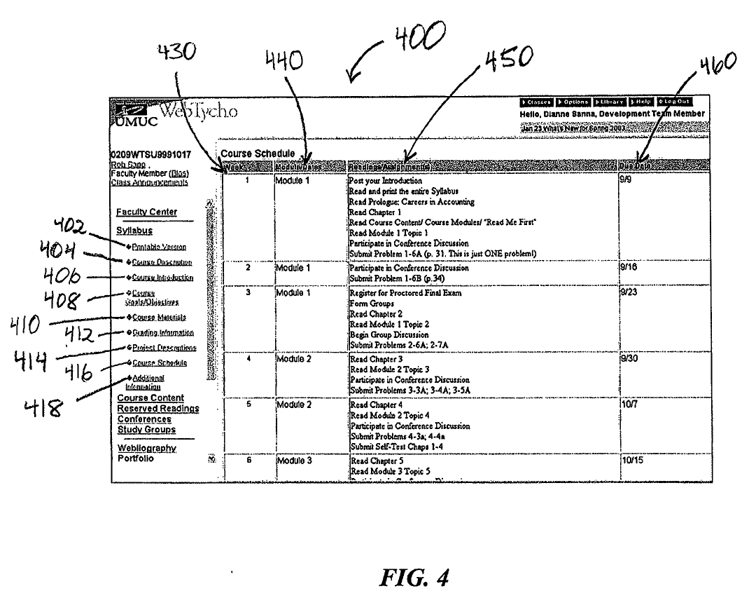

Syllabus. The online syllabus 142 may contain the same information that syllabi do for traditional, face-to-face classes, including required materials, projects, and course schedule. It is further contemplated that the online syllabus contains additional information than that presented in alternative forms of the syllabus. Screen 400, shown in FIG. 4 provides an example of the various functional features that may be provided through the syllabus 142. In the current embodiment, the syllabus 142 allows a user to select from amongst various functional options including Printable Version 402, Course Description 404, Course Introduction 406, Course Goals/Objectives 408, Course Materials 410, Grading Information 412, Project Descriptions 414, Course Schedule 416, and Additional Information 418. Course Schedule 416 is shown as the selected function in the display section 170 of the screen 400. The Course Schedule 416 provides information about the course through a Week 430 sub-section. Each of the further sub-sub sections within the Week 430 sub-section are associated with the sub-sub sections of sub section Module/Dates 440, Readings/Assignments 450 and Due Date 460.

Those with the appropriate permission level (i.e., Faculty) may edit and create certain sections of the syllabus. In the current embodiment, edit access is determined by academic division (Graduate School, School of Undergraduate Studies, European Division, Asian Division.) However, permission for edit access may be determined at the administrative or other permission level as configured by the construct of the current invention.

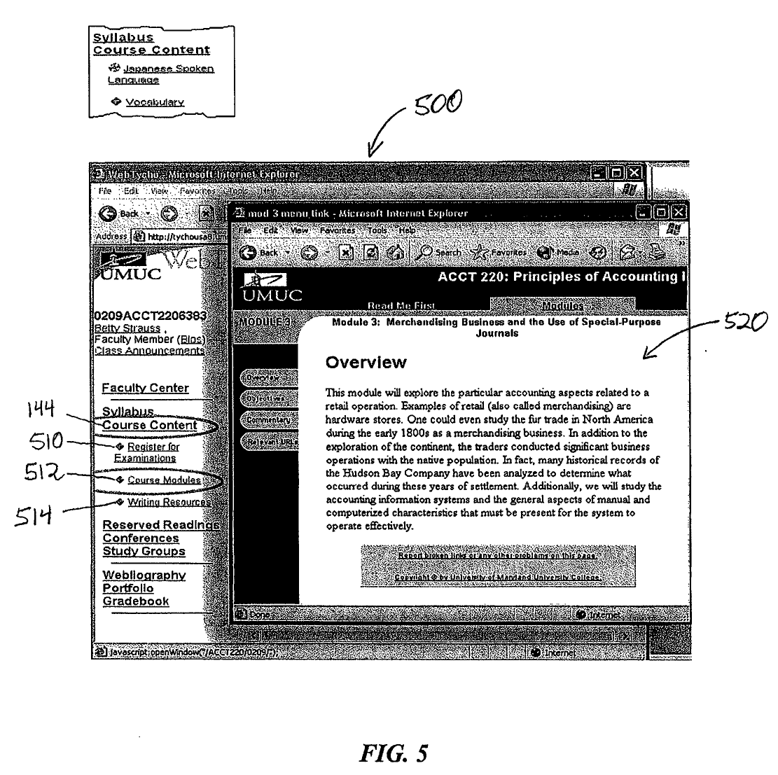

Course Content. Display 500 of FIG. 5, shows the function Course Content 144 as having been selected. Course Content 144 is the online equivalent of face-to-face lectures. In a preferred embodiment, course content 144 includes other decision cells/functional capabilities, such as Register for Examinations 510, Course Modules 512, and Writing Resources 514. It is contemplated that other decision cells may be presented to the user with the appropriate permission level(s). In the current embodiment, course modules 512 has been selected and a display 520 of this function is made in section 170 of screen 500. Display 520 includes various information and decision cells/functions to the user.

In a preferred embodiment, course content is non-interactive (interactivity takes place in conferences.) Content is presented as read-only material for students and contains course material including lectures, assignment descriptions, and various other documents that students will use to study for the class. The decision construct of the current invention allows policy (i.e., Academic Policy or other relevant policy(s) to the networked computing environment) to drive the networked environment. This capability to integrate policy through the entire environment allows the current invention to provide a standardization to the various functions presented within the environment.

FIGS. 1-5 provide a graphical representation of the networked environment as an example of what may be commonly referred to as a “Skin”. The Skin is the graphical layer (display or appearance) presented by the application through the networked environment. The Skin may be created outside the decision construct or subject to the decision construct. The Skin may be created in various manners and applied throughout the network in numerous ways as may be contemplated by those of ordinary skill in the art. In a preferred embodiment, the Skin is determined on a by School basis. For example, the networked environment for the school of law includes displays of similar appearance. However, the engineering school may include displays of similar appearance but not similar to the displays provided for the school of law. Alternatively, the Skin may be determined on a different basis than by School. It is contemplated that multiple Skins may be allowed within various departments, divisions, schools, or other groups. In an embodiment where the Skin(s) is created subject to the decision construct, the various permission level access and restriction requirements shall apply to the decisions that may need to be made in order to implement the Skin(s).

Assignments (All Assignments 154 and Unread Assignments 156).

Students: Students turn in personal assignments to their instructor through the Assignments Folder. Their submissions are available only to themselves and to class faculty. Alternatively, the decision construct may allow certain permission levels to access the assignment folders. Assignments may be created with text boxes integrated into the learning platform, or as file attachments. Students may save and edit assignments as often as they wish, and once they submit for grading they lose edit access. Once an instructor grades an assignment, it disappears from the assignment folder and reappears as a read-only document in the student's portfolio with a grade beside it. It is contemplated that some assignments may not be submitted through the Assignment Folder and are instead submitted via e-mail or via online forms. The decision construct may allow for the entry of an electronic version of the assignment by a permission level other than the student into the assignment folder.

Faculty: Faculty create and edit assignments and instructions with the Gradebook. When students submit assignments for grade, their submissions appear in the Gradebook where faculty review the work and assign grades. Assignments not submitted in the Assignment Folder may also be tracked within the Gradebook. In a preferred embodiment, the Gradebook provides tables that resemble spreadsheets for the entry and tracking of student grades. These spreadsheets may be manipulated as contemplated by those of skill in the art to provide summary and other information.

Reserved Readings 146. Faculty and other designated permission levels may post read-only, online documents for student viewing. Some Reserved Reading may be links to outside web sites. To read a Reserved Reading, click on Reserved Reading on the Class Menu, and then select a link in the Reserved Reading sub-menu. If there are no links shown, then the instructor has not submitted documents.

Study Groups 150. Study Groups make online collaborative work among members of small groups possible. They may be managed by the faculty member or others with the appropriate permission levels and may be accessible only to those members rostered into the study group (a subset of the entire class) by the manager (i.e., faculty member). Study Group discussions take place in the group's conference area and chat room within the networked environment. Within each study group, students and faculty may:
Participate in conferences available to study group members only, exactly as in regular class conferences.
Create and edit collaborative documents, allowing group members to contribute to a common document in a text box.
Attach files that WebTycho's® collaborative documents feature cannot create (e.g., spreadsheets and slide presentations) but may be submitted along with collaborative documents.
Discuss collaborative projects in a real-time (e.g., synchronous) chat session available only to study group members.
Use e-mail links to faculty, teaching assistants, and students listed on the study group roster.

Webliography 152. Students and faculty may compile a shared list of web sites relevant to the class and may add to the webliography at any time throughout the semester. Students may be given permission to delete or edit their own postings. Faculty may rearrange the listing order of webliography items and may delete any webliography item at any time. Clicking on a web site from the list will open the site in its own window.

Portfolio 158. All class students, faculty, and teaching assistants have Portfolios that are read-only records of all online activity, with the exception of Saved assignments. All faculty members may view portfolios for all class members. Faculty may access all Portfolios through Class Members and through the Gradebook, and each person may access their own Portfolio directly from the Class Menu. WebTycho®, automatically updates portfolios each time users submit conference notes, create or edit a collaborative document, submit assignments, post grades, and mark assignments as read [by the instructor].

Each Portfolio contains:
List of all graded assignments and a link to the assignment itself.
List of all assignments submitted for grade and marked as read by the instructor, but not yet graded.
List of all notes the class member posted in conferences. Each listing is linked to the referring note.
List of all collaborative documents the class member worked on. Each listing is linked to the referred to note.

Class Members 164. Class Members provides a numbered listing, by full name (not user name) of everyone registered for the class, including faculty members, teaching assistants, and visitors, with links to each member's e-mail address, in a preferred embodiment of the invention. A checkbox appears beside each name and those selected will be added to an e-mail message distribution list. Visitors to the class are included in the Class Members listing. Beside your name and visible only to you is a link to your personal portfolio.

Chat Room 162. Classmates participate in synchronous (realtime) discussions. Participants see each other's text in a shared dialogue area. The discussion feature is built in and the user does not have to obtain additional software to participate. Participation is optional.

Biography. All class members may choose to create a single autobiography. All biographies will remain permanent from class to class, and may be edited by the owner at any time. Material(s) posted in the biography area is typically public and standard practices of professional demeanor and courtesy apply.

Gradebook 160. The Gradebook is a spreadsheet-type location within the system where faculty may record grades for all student work. The Gradebook also provides a tool for publishing assignment instructions. When used together, these two functions provide a powerful way for faculty to manage all graded work prepared by students.

From this one place faculty may publish detailed and complex assignment instructions and then edit or delete these instructions at another time view a table display of all tasks that have been assigned to students (whether published in Assignment Folders or not) view at-a-glance a table display of all student grades for all assignments view at-a-glance a table display of all grades assigned for a particular assignment read individual student submissions and then assign grades to them or return them to the student for revision and re-submission for grade manually change previously posted grades view student portfolios compute final grades.

The Gradebook is integrated with students' Assignment Folders so that instructions created in the Gradebook may be automatically published to Assignment Folders, and conversely, assignments submitted through Assignment Folders are automatically recorded in the Gradebook. The Gradebook is also integrated with Portfolios and assigned grades are automatically posted there. However, graded work that cannot be submitted through the Assignment Folder, such as class participation and lab reports, may still be included in the Gradebook for tracking and final grade computation.

Assignment components include:
Title
Type of assignment
Grading method (Letter, Points, Pass/Fail, and Percentage)
Weight (relative to other assignments)
Due date (optional)
Lock date (optional)
Ability to publish this assignment to Assignment Folders (optional)
Text box for narrative instructions
Text box for notes to other class faculty only

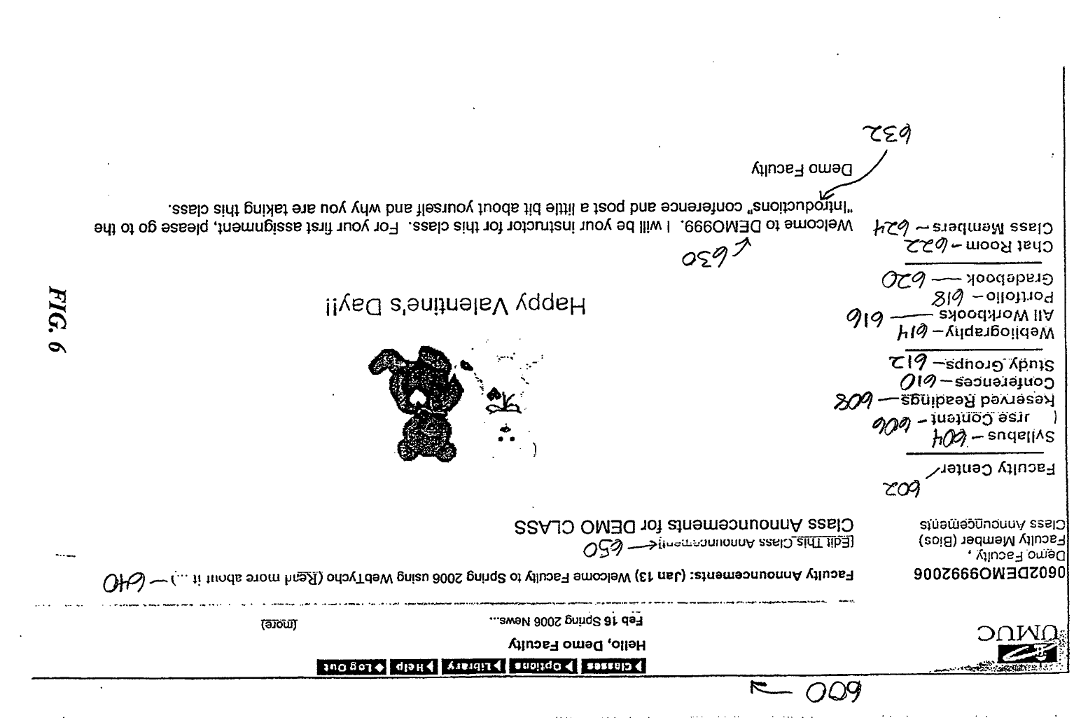

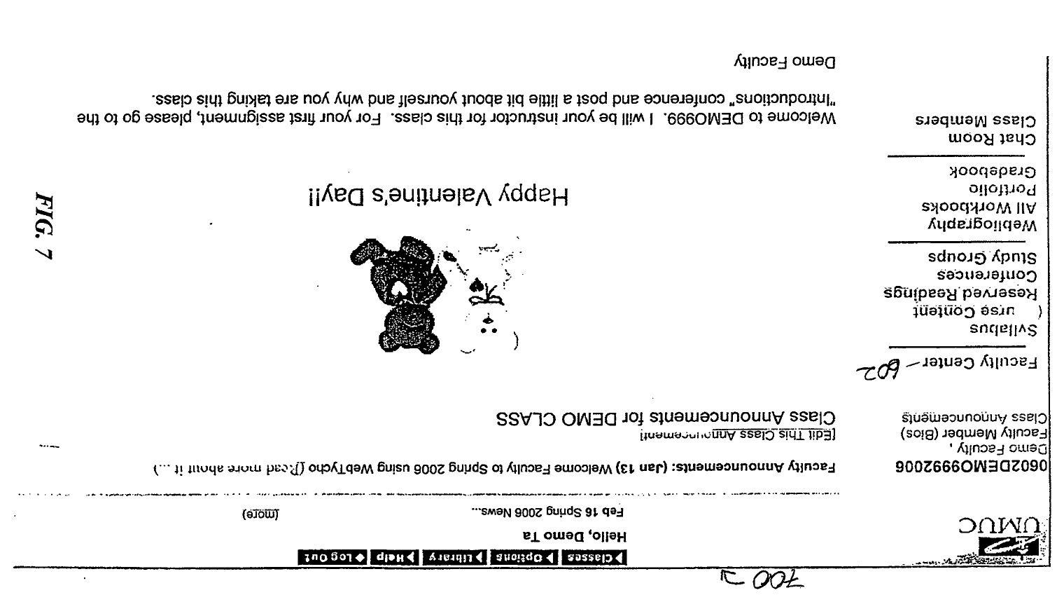

In still further exemplary embodiments of the current invention enabled over a networked computing environment, such as a learning platform, the configuration of the information presented may vary based upon decision input through the decision construct and implemented in the networked environment. In general, FIGS. 6-16 present a similar networked computing environment, configured by the decision construct of the current invention, to that shown and described above for FIGS. 1-5. It is to be understood that any differences between the networked environments may be a result of a different configuration for the networked environments that is allowed by the decision construct. For example, in FIGS. 6 and 7, it may be seen that the “Faculty Center” function 602 is repositioned, when compared to the positioning of this function shown in FIGS. 1-5. The System 122 function shown in FIGS. 1-5 is not present in FIGS. 6-16. It is contemplated that the configuration of all the information being presented on a screen of a networked computing environment, such as the learning platform, that implements the current invention may vary. For instance, the screen position of the functions being presented may vary. It is still further contemplated that the functions of the learning platform that may be affected by the decision construct of the current invention may be grouped together in pre-determined patterns or may be allowed to be grouped or not grouped by a permitted user of the system. These groups of functions may be variously repositioned within a display screen or other display form or device.

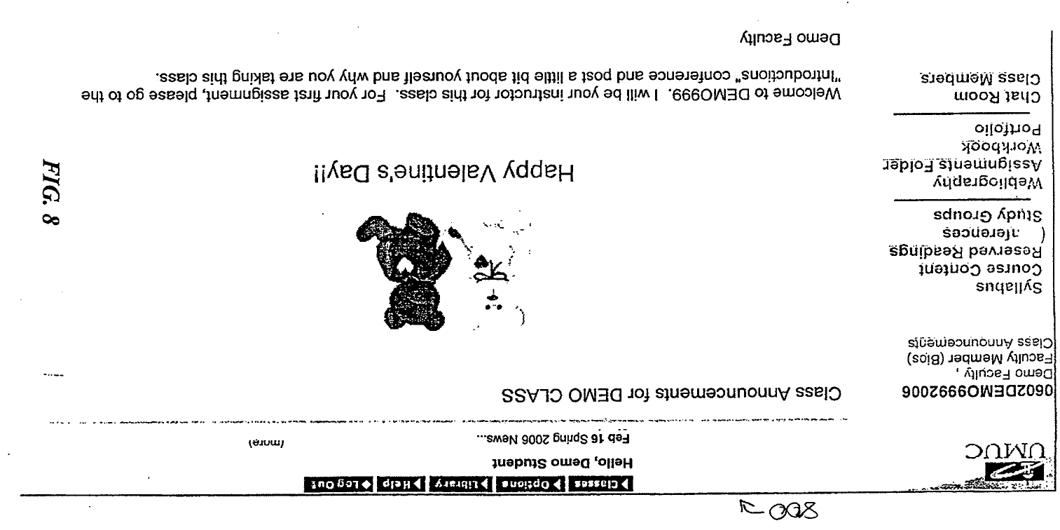

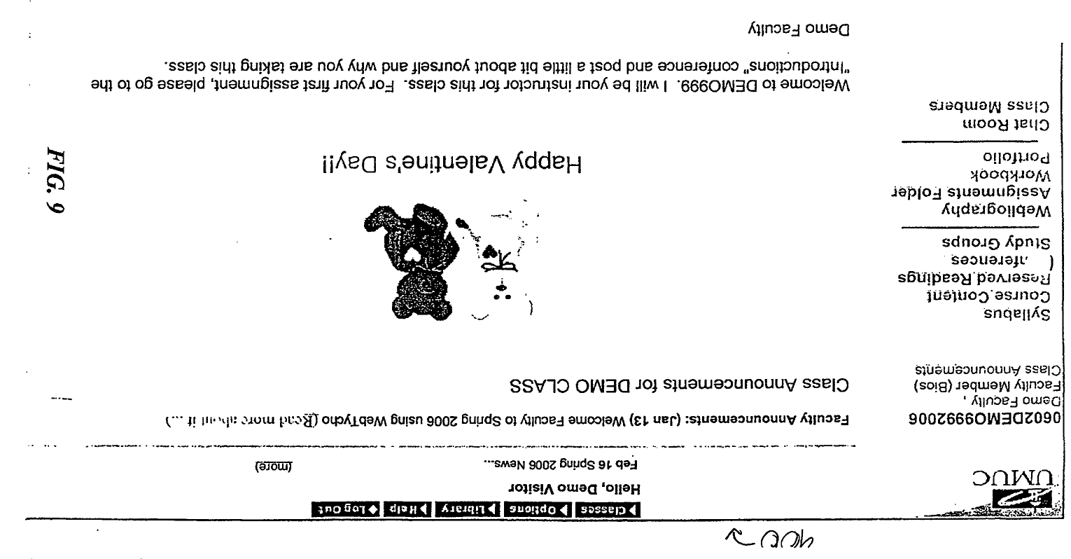

In FIGS. 6-9, four different exemplary screen shots are shown corresponding to four different permission levels in accordance with a preferred embodiment of the present invention. The decision construct determines the access to be given to a user having a specified permission level to decision cells where the user (permission level) may enter decisions through the construct that effect change to the information and functional capabilities provided over the networked computing environment (i.e., learning platform). FIG. 6 is an exemplary screen shot of a permission structure that is associated with a level identified as “Faculty” 600. FIG. 7 is an exemplary screen shot of a permission structure that is associated with a level identified as “Ta” 700 or Teaching Assistant. FIG. 8 is an exemplary screen shot of a permission structure that is associated with a level identified as “Student” 800. FIG. 9 is an exemplary screen shot of a permission structure that is associated with a level identified as “Visitor” 900.

It is to be understood that the permission structure(s) associated with the various different levels, as identified on the screen shots, may be variously configured. For instance, the permission structure of any of the identified levels may be adjusted by either adding or removing decision cells (i.e., decision inputs that the user may make, such as functions that the user may select) to another level within the decision construct, to another location within the networked environment, or removing them completely from the construct. It is further contemplated that the number of levels may be varied, as described above. In the current exemplary embodiment, we have identified a decision construct that has four (4) levels of permissions associated with it. Alternatively, the construct may have fewer than four or greater than four levels of permissions without departing from the scope and spirit of the present invention.

The various functions presented in the learning platform comprise decision cells that are associated with the user/permission level, whereby the construct presents decisions (i.e., “links”) that the user may select for the performance of management/administrative functions. The learning platform is configured to receive the decisions entered by a user and display the various decisions. Decisions made and entered through the decision cells of the decision construct by users with higher permission levels, for example those made and entered by users with Faculty or Ta permission levels, may generally be reflected across the learning platform and affect the display provided to those users with lower permissions levels, such as Student and Visitor. Alternatively, decisions made and entered by lower permission levels (i.e., Student and Visitor) may or may not be reflected across the learning platform and/or affect the display provided to those users with higher permissions levels. The display provided to each permission level may include access to the functions of the learning platform and access to various decision cells associated with the functions. Therefore, it may be the case that the subordinate permission levels have a fewer number, if any, of decision cells made available to them as compared to the higher permission levels. Thus, the decision construct may limit the affect the lower permission levels have upon the networked computing environment, i.e., learning platform.

In a preferred embodiment, the decision construct implements decisions from the higher permission levels down through all other permission levels for display. This contiguous format for decision entry may allow for review and comment from the other permission levels or not. It is contemplated that the present invention does not have to implement decisions in such a contiguous manner. The higher permission levels may in effect “skip” the lower permission levels in proceeding to the implementation of their decisions and display through the networked environment. This by-pass capability may be employed by higher permission levels against the lower permission levels, however, the lower permission levels may not have this by-pass capability. The decisions made by the lower permission levels, unless such are inconsequential to the operation of the networked computing environment, may not by-pass the higher permission levels. The higher permission levels may review, comment, and/or edit the decisions of the lower permission levels.

Further, the display of the various decisions made by the users may be nearly instantaneous or delayed. Decisions made by users with certain permission levels may be delayed in their implementation within the learning platform until review and authorization is provided with a user having a higher permission level or by other management system protocols as may be contemplated by those skilled in the art.

Within the decision construct, decision cells are an authority granted to a permission level (user) to “Decide”/access functions and/or edit information that may be made available through the networked computing environment. Thus, decision cells are in effect permissions granted or functions made available to a user with a particular permission level to have access to and make particular decisions that may be implemented upon and throughout the networked environment. As an initial example, the assignment of different permissions amongst the permission levels identified by our exemplary screen shots in FIGS. 6-9 is the presence or absence of the “Faculty Center” 602 function upon the display screen presented to each level. FIGS. 6 and 7 illustrate exemplary screen shots of a learning platform for a user with the permission level of Faculty and Ta, respectively. The “Faculty Center” 602 function is presented as part of the list of functions available to the “Faculty” and “Ta” levels. In FIGS. 8 and 9 the “Faculty Center” function is not presented as part of the list of functions available to the “Student” and “Visitor”.

In the current embodiment shown in FIGS. 6-9 the various permission levels are provided with various similar decision cells. Each permission level shows access to the following decision cells: Syllabus 604, Course Content 606, Reserved Readings 608, Conferences 610, Study Groups 612, Webliography 614, All Workbooks 616, Portfolio 618, Gradebook 620, Chat Room 622, Class Members 624, Class Announcements 626, and Faculty Member (Bios) 628. The “Welcome” 630 descriptive language provided in FIGS. 6-9 may also include an “Introductions” 632 decision cell that allows the users access to another decision cell for entry of information about themselves as described. Further, FIGS. 6, 7, and 9 provide an additional decision cell that is displayed as “Faculty Announcements” 640. The Edit This Class Announcement 650 function included on display 600 and 700 may allow for direct access to an editing capability for information to be presented on these screens.

It is contemplated that the assignment of the various decision cells to the “Faculty” and “Ta” may occur from another permission level, not shown, or by either the “Faculty” or “Ta” level, or by both of these two levels. In a preferred embodiment, the “Faculty” permission level is granted full access to the system, as will be described in greater detail below, therefore in this example the user identified by the “Faculty” level may determine and assign the decision cells/permissions that may be accessed by the other subordinate permission levels.

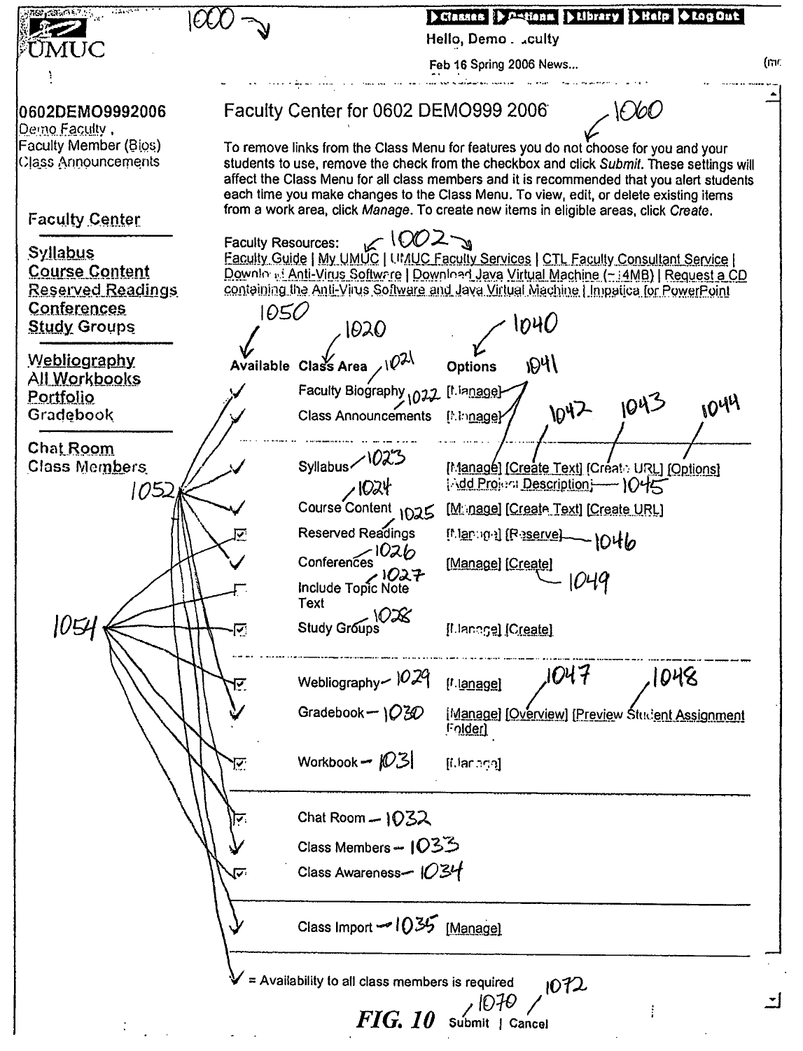

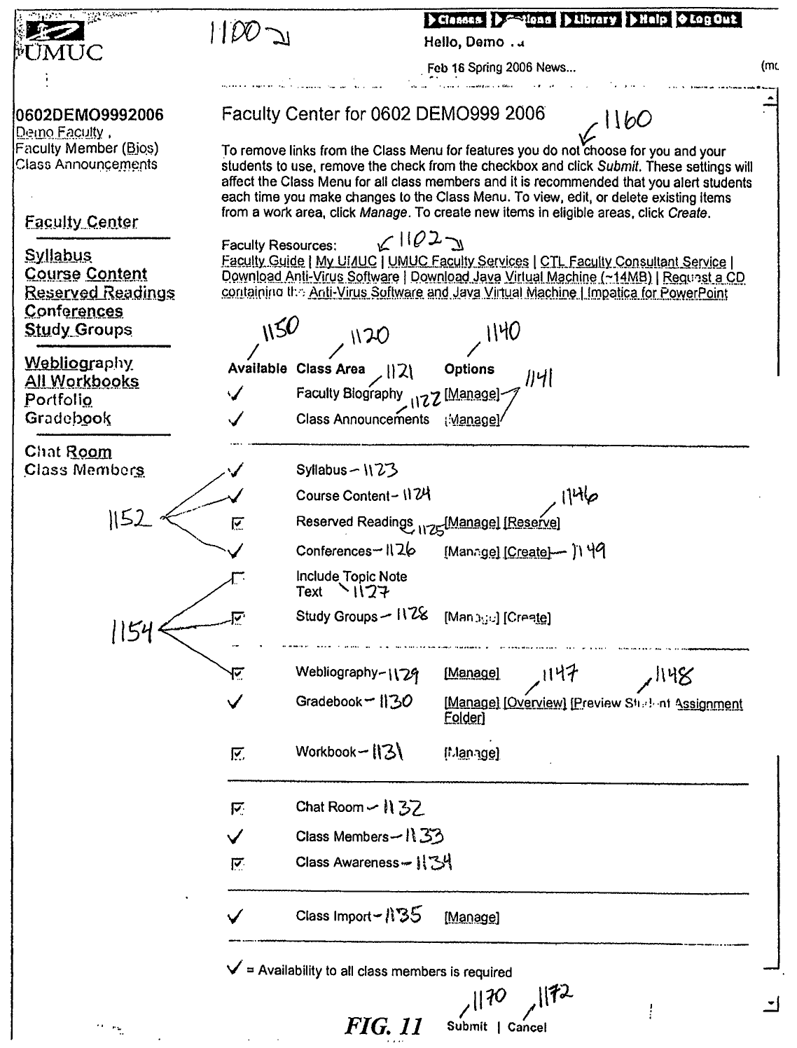

In an exemplary embodiment of the present invention, the selection of the “Faculty Center” function 602, such as through a point and click method enabled by a mouse communicatively coupled with the networked computing environment of the learning platform, is an example of a user making a decision and effectively interfacing with the decision cell. Once the user with the Faculty permission level access makes and enters the decision the user is taken to another location within the learning platform, as shown in FIG. 10. This screen 1000 provides information, such as written description 1060 of actions that may be taken and links to “Faculty Resources” 1002 which may be accessed from this screen. The “links” presented to this user are a further example of decision cells, functions, or permissions that are being made available to this permission level by the decision construct of the current invention. For example, the user with “Faculty” permission level is presented with a menu that allows the user to make decisions regarding functions that other users with different permission levels may or may not have access to or be allowed to make. The functions are listed under the heading “Class Area” 1020 in FIG. 10 and include, Faculty Biography 1021, Class Announcements 1022, Syllabus 1023, Course Content 1024, Reserved Readings 1025, Conferences 1026, Include Topi Note Text 1027, Study Groups 1028, Webliography 1029, Gradebook 1030, Workbook 1031, Chat Room 1032, Class Members 1033, Class Awareness 1034, and Class Import 1035. While the list provides numerous functions, it is to be understood that the configuration, such as the number of functions listed, display of the list on the screen, and capabilities and/or content represented by each function, may vary. Display 1100 of FIG. 11 displays similar functional component features as shown in Display 1000 of FIG. 10. A difference in configuration, as dictated by decisions entered through the decision construct, is noted under the Options heading. Display 1000 (FIG. 10) presents several different functional components that are not provided in display 1100. Such differences in configuration may be realized through the decision construct wherein the permission level(s) with decision making authority over the configuration of these two displays for these two different permission levels may be allowed to determine which functions will and will not be displayed on the various screens.

FIG. 10 also shows that the heading “Available” 1050 presents two exemplary types of decisions that are reflected in or accessed by the Faculty permission level. There are indicators 1052, in the current example check marks, next to listed functions for which the user does not have access (access being the ability to make a decision through the availability of a decision cell). The decision may result in certain materials or functions in a course being offered or displayed over the learning platform. In this example, when this type of indicator is found next to a listed function it identifies to the user that this function is mandatory for the course being offered and that their permission level does not grant them access to a decision cell regarding this function, therefore, the user is not able to change (edit) the status of this function. Thus, the user may not elect whether or not this function is included in the available materials for the class.

The decision cells 1054, represented as boxes in the current embodiment, are located in corresponding position to a particular function. The box is a decision cell that allows a user to elect whether or not the function will be included in the available class materials. Thus, the user is presented with a decision in which they may elect to include the function by placing an appropriate indicator, in this case a check mark, in the box. The addition of the check mark to the box may occur through various means as are known to those of ordinary skill in the art. Thus, if the user wishes to make this class material available to the other users of the learning platform they may place a check mark in the box. Once this decision is made, the class materials may be made immediately available or their availability may be delayed, as described above. If the user does not wish to make this function an available class material, then they may elect to leave the box unmarked, as is shown in the box next to the function “Include Topic Note Text” 1027.

The description above provides two examples of decision cells embodied in links and functional indicators, which may or may not be made available to a user with a particular permission level. The links are access decisions assigned to particular permission levels that may allow the user to access other decision cells (i.e., links and/or functional indicators). The functional indicators are functional decisions that may be made by a user with a particular permission level. The decision made in the functional indication decision cells may result in the editing of the networked computing environment. For instance, the functional indication decisions may edit information presented over the network, edit the decision cells to be made available to various permission levels, edit the assignment of permission levels, and perform various other functions as may be contemplated by those of ordinary skill in the art.

Other decision cells made available to the user at this permissions level are shown as various functions (i.e., links) under the heading “Options” 1040. In the current embodiment, these functions include [Manage] 1041, [Create Text] 1042, [Create URL] 1043, [Options] 1044, [Add Project Description] 1045, [Reserve] 1046, [Overview] 1047, [Preview Student Assignment Folder] 1048, and [Create] 1049. Different functions under this heading may be and are associated with the various functions listed under the “Class Area” 1020. It is contemplated that any number, including zero, of the functions identified under the “Options” 1040 may be associated with any one of the functions under the “Class Area” 1020. It is further contemplated that other functions may be listed under and correspondingly associated with the different headings shown.

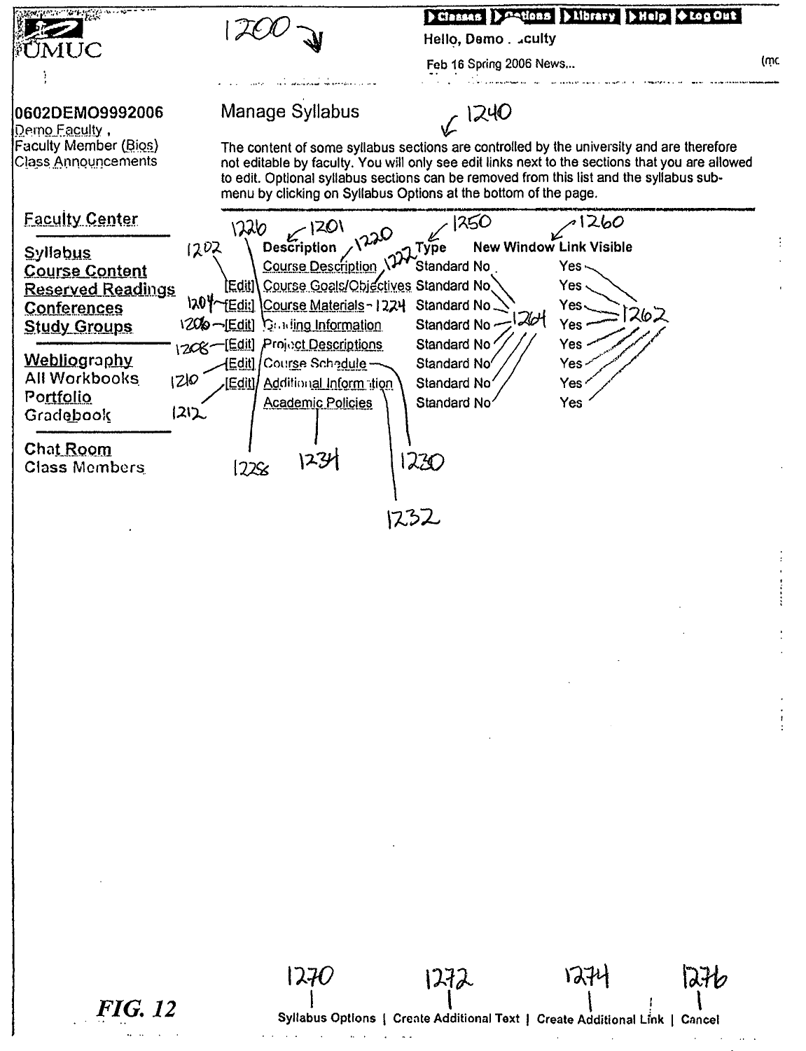

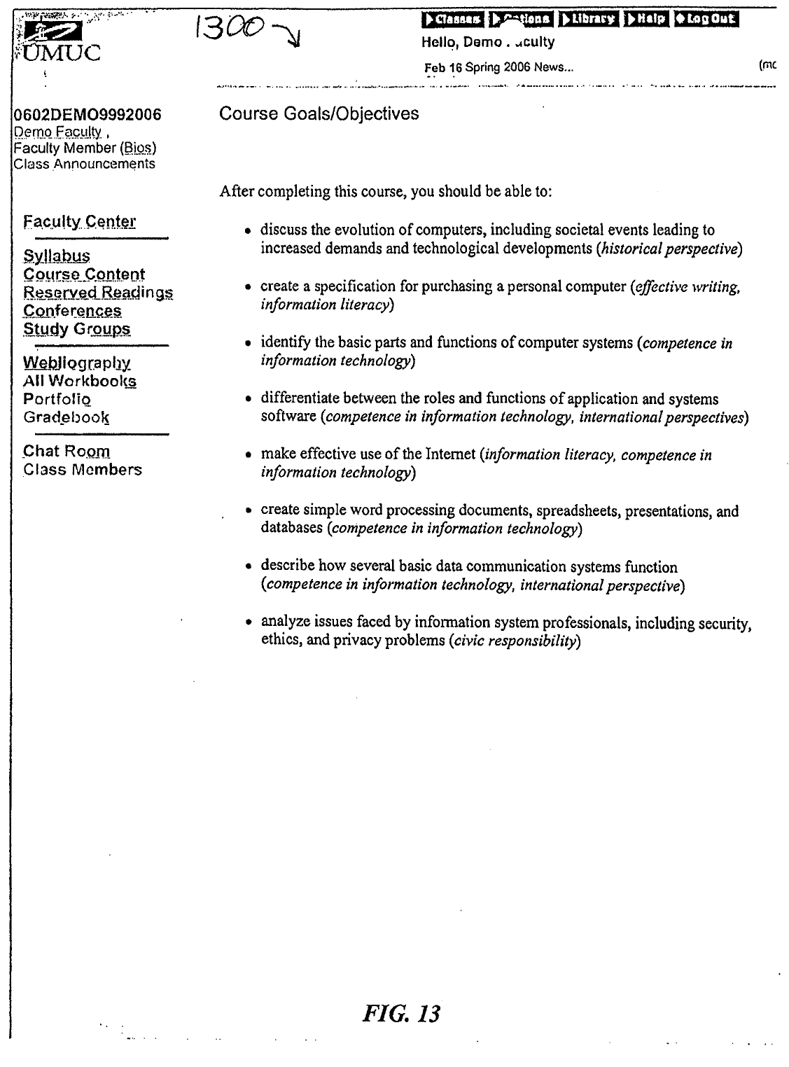

When any one of the functions under the “Options” 1040 heading is selected the user may be taken to another location within the learning platform. For instance, when the “[Manage]” option 1041 associated with the “Syllabus” function 1023 listed under the “Class Area” 1020 is selected by the user, the user is taken to the exemplary screen 1200 shown in FIG. 12. FIG. 12 presents additional information (i.e., descriptive language) and functions (decision cells) that may be selected by the user and take the user to other locations within the networked computing environment where further information and decision cells may be presented such as those shown in FIGS. 13-16.

While the screens shown in FIGS. 6-16 are exemplary and representative of the information and decision cells that may be made available and accessed by various users having various permission levels, it is to be understood that the information and decision cells/functions accessed through these links and the implementation of the decisions within any networked computing environment may vary significantly from one another without departing from the scope and spirit of the present invention. For example, when the user selects the “edit” function 1208 corresponding with the “Project Descriptions” function 1228 on the “Manage Syllabus” screen 1200, the user may be taken to a location containing various information and enabled with various decision cells/functions that may or may not be similar to those shown in FIGS. 13-16. This location may allow the user to make further decisions through decision cells which may take the user to various other locations that present further decision cells to the user, and so on. It is contemplated that the number of decision cells/functions and information made available to the user through decisions entered into decision cells provided by the present invention may be set at a predetermined number or may be unlimited. In a similar manner when the user selects the “edit” function 1210 corresponding with the “Course Schedule” function 1230 on the “Manage Syllabus” screen 1200, the user may be taken to another alternative location within the learning platform providing various alternative information and enabled with various alternative functions that may or may not be similar to those shown in FIGS. 13-16.

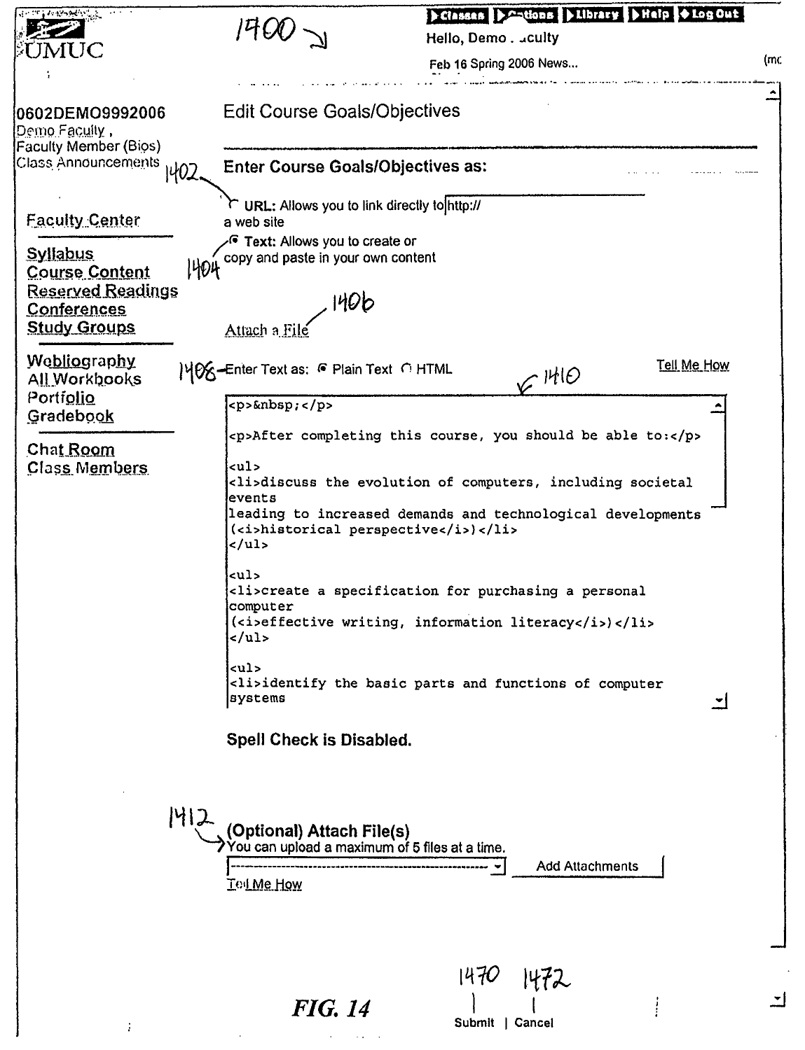

FIGS. 10, 11, 12, and 14, provide examples of further decision cells/functions that may be made available over the networked environment. Proximal to the bottom of each illustration, there are provided additional decision cells. FIG. 10 provides decision cells 1070 and 1072, FIG. 11 provides decision cells 1170 and 1172, FIG. 12 provides decision cells 1270, 1272, 1274, and 1276, and FIG. 14 provides decision cells 1470 and 1472. These additional decision cells may allow the user to implement the types of changes previously described above. Access to these decision cells may be limited to certain permission levels as determined through the configuration of the decision construct. For instance, if only the Faculty permission level were given access to these locations then these decision cells would be effectively limited to a user with the Faculty permission level. However, it is contemplated that these decision cells may be made available to one or more permission levels.

Under the heading “Description” 1201 on the “Manage Syllabus” screen 1200, the user is presented with another list of functions accessible through the selection of links. FIG. 8 illustrates screen 800 for “Course Goals/Objectives” 1222. The exemplary screens accessed through the selection of “Course Description” 1220, “Course Materials” 1224, “Grading Information” 1226, “Project Descriptions” 1228, “Course Schedule” 1230, “Additional Information” 1232, and “Academic Policies” 1234 may be similar or contain alternative information and functions to those shown in FIG. 12. Additional descriptive information and potential functional capabilities may be presented through the various other sections of display 1200 including the written description section 1240, section 1250 under the heading “Type”, and section 1260 under the heading “New Window Link Visible”. Section 1260 provides the user with a Yes 1262 or No 1264 decision regarding link visibility. Other decisions may be presented without departing from the scope and spirit of the present invention. The configuration, such as the type of information, display of the information on the screen, functions provided, and various other features as may be contemplated by those of ordinary skill in the art, may vary. It is also contemplated that each of the screens accessed within the network may be edited to present alternative information and/or functions.

FIG. 13 provides another exemplary embodiment of a display 1300 that may be presented to a user of the networked computing environment including the decision construct of the current invention. Display 1400 of FIG. 14, is accessed through selection of the “edit” function 1202 for “Course Goals/Objectives” 1222 from screen 1200. In FIG. 14 the user may select, from multiple decision cells, their preferred way for entering information into the networked computing environment through the construct of the network under the course goals/objectives function 1222. A decision cell 1402 allows the user to select the option of providing a URL link. The decision cell 1404 allows the user to create, in various manners, their own text to be entered. A decision cell 1406 allows a user to determine if they are going to attach further files. A decision cell 1408 may allow a user to enter text into the networked computing environment in a particular format and then provides an entry box 1410 that allows for information to be input by the user. Another decision cell 1412 provides the user with the capabilities to locate and attach certain files. These decisions allow the user to determine the type of information that will be provided under the “Course Goals/Objectives” function 1222 and also allows them to determine the way in which such information will be entered into the learning platform. It is contemplated that there may be functional relationships between the various decision cells that are presented to a user. For example, in FIG. 14, the decision cells 1406 and 1412 may provide a similar or different functional capability to the user through this screen. It is to be understood that the current invention may allow for various relational configurations in and between the numerous decision cells provided without departing form the scope and spirit of the present invention.

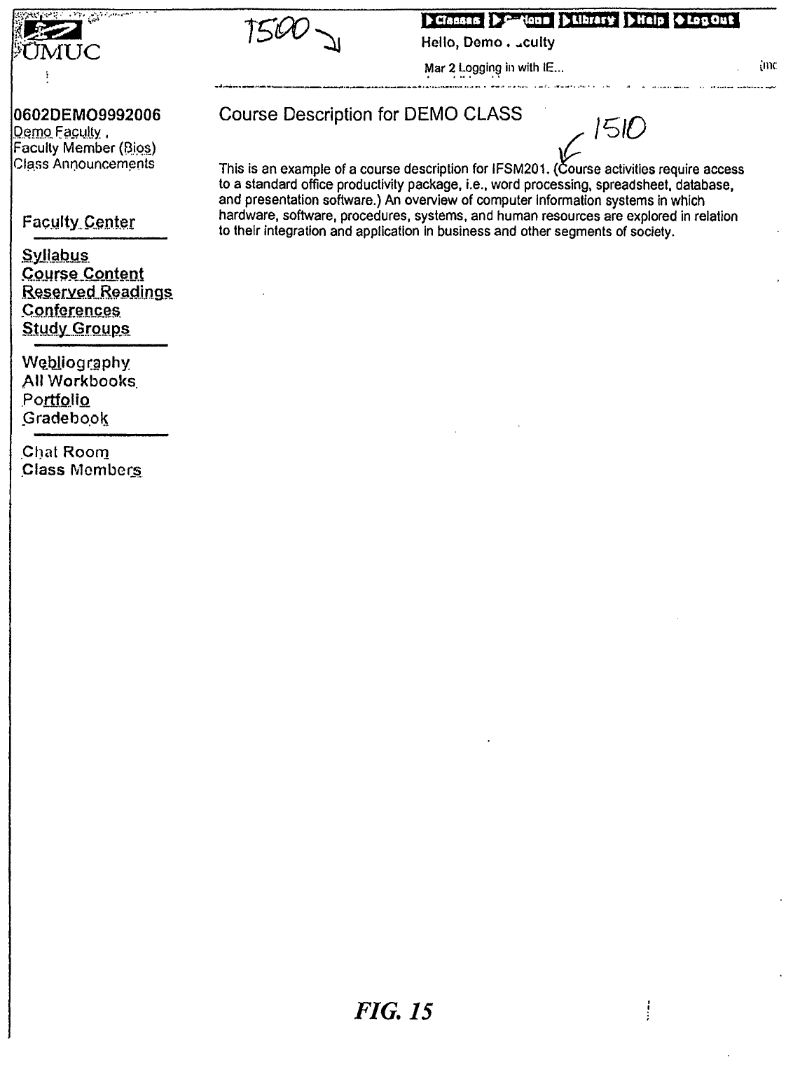

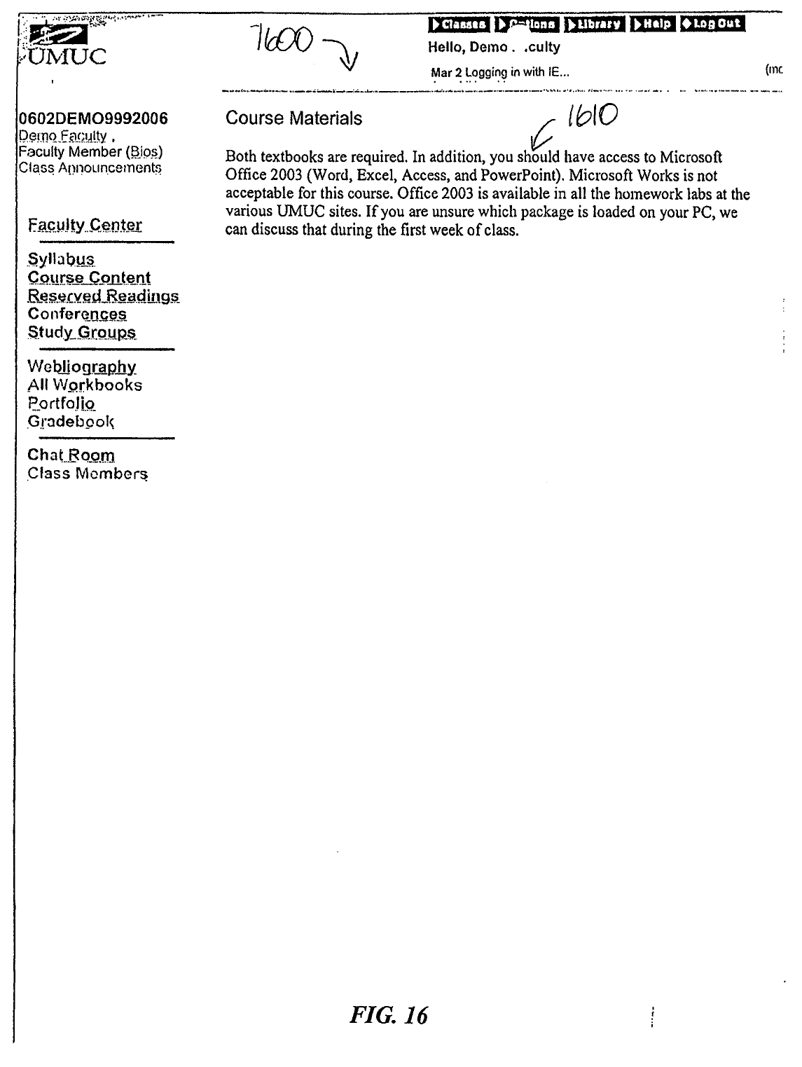

Display 1200 includes the course description 1220 function, as previously identified. Upon selection by a user with access to this decision cell, the user may be taken to the screen 1500 shown in FIG. 15. Upon selection by a user with access to the course materials 924 function on screen 1200 the user may be taken to the screen 1600 shown in FIG. 16. The Course Description screen 1500 and Course Materials screen 1600 may provide descriptive information within section 1510 and section 1610, respectively, regarding the particular course at issue and the materials that are required. It is further contemplated that various other types of information and/or decision cells may be presented to the user within these further screens accessed by previous decisions from the user.

The various functions that are found under the headings shown in FIG. 10, i.e., “Available” 1030, “Class Area” 1020, and “Options” 1040, may allow the user to select them through a point and click procedure and may grant the user access to other locations within the network that may provide further information and decision cells/functions and allow the user to access still further alternative locations. It is contemplated that the number of decision cells/functions found under these headings may be determined by decisions made within the decision construct by a user with the appropriate permission level. For instance, a location within the networked computing environment implemented with the decision construct and accessible by the Faculty level user may allow this user to edit the number and types of decision cells/functions presented under these headings. It is contemplated that other permission levels may also be permitted to access and make decisions within decision cells regarding the number and type of decision cells/functions to be made available under these headings, in accordance with the contemplated capabilities of the current invention. It is also contemplated that the number of headings displayed to the different users having different permission levels may be varied. The decision construct may allow certain permission levels to change the headings presented to the other permission levels and determine the functions to be made available under the headings. The decision construct allows these types of decisions to be made through decision cells made available to one or more permission levels.

As previously mentioned, FIG. 10 shows the various decision cells/functions/permissions that are assigned to the Faculty permission level when such a user selects and is directed to the “Faculty Center” screen 1000, as described above. By way of comparison, display 1100 of FIG. 11 shows the various decision cells/functions/permissions that are assigned to the Ta permission level when such a user selects and is directed to the “Faculty Center” screen 1100. According to the decision construct of the present invention, the Ta permission level allows the user access to similar information that the Faculty permission level user is allowed to access. However, the Ta is not given similar permissive access to functions under the “Options” 1140 heading corresponding to the Syllabus 1123 and Course Content 1124 functions found under the “Class Area” 1120 heading. Thus, the decision construct of the present invention provides a differentiation between the decisions allowed to be made by these different permission levels. The presence or absence of decision cells/functions, such as those found under the “Options” headings 1040 and 1140 for the Faculty and Ta user provide another clear example of the implementation of the current invention across a networked computing environment.

FIGS. 8 and 9 illustrate screen displays 800 and 900 provided for a Student and Visitor permissions level implementing the current invention. Nowhere within the screen is access to the Faculty Center 602 made available. This is another clear example of how the implementation of the present invention may be realized within the networked computing environment, such as the learning platform. It is contemplated that a user having a higher permission level was presented a decision cell for determining what types of functions are to be available to the users with lower permission levels. Further, this user with the higher permission level may have entered into the decision cell the command to not make the Faculty Center function 102 available to the users with lower permission levels. This decision, entered through the decision cell, is displayed in the learning platform by the absence of this function as an available option for the users with the lower permission level.

It is to be understood that the various decision cells/permissions/functions made available to the different users with different permission levels by the decision construct of the current invention and as deployed over a networked computing environment, may vary. For instance, the Ta may have its access to the Faculty Center 602 removed while the Student may be given access to the Faculty Center 602. Alternatively, access by one permission level to one or more decision cells/permissions/functions may be limited when compared to other permissions levels. This is shown in FIGS. 10 and 11 between the Faculty and Ta permission levels. Overall, the decision construct may allow a user with the appropriate permission level to determine, assign and vary the number of available decision cells/permissions/functions assigned to each permission level.

It is contemplated that the decision construct may include the capability to display a screen (not shown) that allows a user with the appropriate permission level to manage the entire networked environment and affect changes throughout. This administration screen may contain a display of all decision cells made available by the decision construct to all the permission levels. The permission level that is allowed access to this screen may create, edit, or delete decision cells from within the decision construct. Further, the user with access to this screen may assign decision cells to the different permission levels or edit the decision cells that are currently available to the different permission levels. From this screen new permission levels may be created and assigned to different users or permission levels may be deleted and users removed from their ability to access the learning platform. Other administrative functional capabilities, as may be necessitated by the policies of particular institutions, may be added or removed from this screen allowed by the decision construct.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A decision construct for configuring a networked computing environment, comprising:
a first command for designating permission levels and associating users with each of the permission levels;
a second command for associating decision cells, affecting functional capabilities of the networked computing environment, with each of the permission levels; and
a third command allowing input of decisions into decision cells by the user,
wherein the user decisions control the operation of the networked computing environment.

2. The decision construct of claim 1, further comprising a command allowing editing.

3. The decision construct of claim 2, further comprising a command that controls the implementation of the editing allowed through the editing command.

4. The decision construct of claim 1, further comprising a command allowing higher permission levels to associate decision cells with lower permission levels.

5. The decision construct of claim 1, further comprising a command providing at least one of encryption, alerts, stops, and a user interface.

6. The decision construct of claim 5, wherein the at least one command that is executed is executed automatically by the construct.

7. The decision construct of claim 1, further comprising a command that populates fields of a user interface provided by the networked computing environment with decision cells of the decision construct.

8. The decision construct of claim 1, further comprising a command allowing review of information entered through the decision cells.

9. The decision construct of claim 1, further comprising a command allowing decisions made at a higher permission level to by-pass lower permission levels.

10. A networked computing system, comprising:
two or more computers communicatively coupled to one another creating a networked computing environment; and
a decision construct loaded upon one or the two or more computers and implemented upon the networked computing environment
wherein the decision construct allows a user to configure the networked computing environment.

11. The networked computing system of claim 10, wherein the decision construct is loaded upon a server that is one of the two or more computers.

12. The networked computing system of claim 10, wherein the decision construct associates the user with a permission level that is associated with a decision cell.

13. The networked computing system of claim 10, wherein the networked computing environment is configured over at least one of the Internet, an intranet, Ethernet, LAN, and WAN.

14. The networked computing system of claim 10, wherein the decision construct provides at least one of a user interface and a user interface that includes fields populated by decision cells of the construct.

15. The networked computing system of claim 10, wherein the decision construct allows editing and the implementation of edits is at least one of real-time or delayed.

16. The networked computing system of claim 10, wherein the decision construct allows the implementation of at least one of alerts, encryption, review, pass down, and stops authority.

17. A method for configuring a networked computing environment, comprising:
implementing a decision construct upon the networked computing environment;
wherein the decision construct allows a user to configure the networked computing environment through the input of decisions into decision cells associated with a permission level to which the user has been associated.

18. The method of claim 17, wherein the networked computing environment includes two or more computers communicatively coupled over at least one of the Internet, intranet, Ethernet, LAN, and WAN, and at least one of computers is a server loaded with the decision construct.

19. The method of claim 17, further comprising the step editing and of implementing edits into the networked computing environment in at least one of real-time and delayed.

20. The method of claim 17, further comprising the step of implementing at least one of a user interface, a user interface that includes fields populated by decision cells of the construct, encryption, alert, stop, pass down, and review authority.
